(19) United States
(12) Patent Application Publication
(10) Pub. No.: US 2014/0222698 A1
(43) Pub. Date: Aug. 7, 2014

(54) Systems and Methods for Tracking Renewable Energy Credits

(71) Applicant: EM Biofuels, LLC, Houston, TX (US)

(72) Inventors: Gauri Potdar, Houston, TX (US); Ken R. Nelson, Houston, TX (US); Mihaly Istvan Wekler, Houston, TX (US); Randall Lack, Houston, TX (US)

(73) Assignee: EM Biofuels, LLC, Houston, TX (US)

(21) Appl. No.: 14/170,259

(22) Filed: Jan. 31, 2014

Related U.S. Application Data
(60) Provisional application No. 61/759,367, filed on Jan. 31, 2013.

(51) Int. Cl. G06Q 30/00

(52) U.S. Cl. CPC G06Q 30/018
USPC 705/317

(57) ABSTRACT

Systems and methods for tracking renewable energy credits are provided. In one embodiment, a system can be provided. The system can include at least one processor. The system can also include at least one memory comprising computer-executable instructions. When the computer-executable instructions are executed by the at least one processor, the instructions cause the at least one processor to receive data associated with renewable electricity generation by at least one power plant, receive data associated with renewable electricity usage by at least one electric vehicle station, and based at least in part on the received renewable electricity generation data and renewable electricity usage data, determine one or more renewable energy credits associated with the renewable electricity generation.

### RELATED APPLICATION

This application claims priority to U.S. Provisional Patent Application No. 61/759,367, entitled “Systems and Methods for Tracking Renewable Energy Credits,” filed on Jan. 31, 2013, the contents of which are incorporated by reference herein in their entirety.

### TECHNICAL FIELD

This disclosure relates generally to tracking automation systems and methods. In particular, certain embodiments relate to systems and methods for tracking renewable energy credits.

### BACKGROUND

Several federal and state level cap and trade programs—including, but not limited to the Renewable Fuel Standard (RFS) and the Low Carbon Fuel Standard (LCFS)—allow for the generation of renewable fuel credits (RFCs) based on the utilization of renewable electricity produced from biogas, biomass, and other renewable resources (hereinafter “renewable electricity”) when sold as transportation fuel. These credits may be either used to demonstrate compliance of the regulated party under the appropriate program; or sold off to other regulated parties, thus increasing the revenue from renewable electricity production and incentivizing its development.

When generating renewable fuel credits it is the obligation of the producer to demonstrate to the appropriate agency that the credits are generated for actual production of renewable electricity and that the production qualifies for environmental credit generation under the applicable program. The requirements for generating renewable fuel credits may include, but are not limited to, the examples that follow.

In the event that renewable electricity is transmitted from the point of generation using common carrier electric power transmission and distribution systems (hereinafter “power grid”): 1) contracts exist for the sale of renewable electricity involved in the pathway; their execution is tracked; 2) a physical delivery path is established between the renewable electricity producer and the point of use of the renewable electricity as transportation fuel; 3) usage of renewable electricity as transportation fuel is tracked appropriately; 4) no more renewable fuel credits are generated than the amount of renewable electricity produced and used as transportation fuel allows for; 5) no other party relies upon the contracted volume of renewable electricity for the creation of renewable fuel credits; and 6) an exact record of renewable electricity sales and distribution is kept.

Some or all of the requirements above for the tracking of renewable electricity generation, transmission and usage may also apply to some or all of the feedstock used in the generation of renewable electricity.

In the event that the renewable electricity is generated on-site: 1) renewable electricity producer's registration with the appropriate agency for renewable fuel credits generation is complete and up to date at all times; 2) regular data collection, aggregation and processing is performed to satisfy reporting and audit requirements of the appropriate agency; 3) production data from the renewable electricity source is tracked continuously; 4) all required information—including, but not limited to, sale and purchase agreements—regarding the connection between the producer of renewable electricity and the entity using the renewable electricity for qualifying purposes, such as charging of electric transportation vehicles (hereinafter “EV station”), is established and collected; and 5) transfer of ownership documentation for renewable electricity and associated credits is tracked and satisfies all applicable regulatory requirements.

In order to satisfy all requirements of environmental credit generation and management, a regulated party may need to be able to track the feedstock acquisition, production and usage of renewable electricity reliably from generation to its' end use as transportation fuel.

There are several challenges associated with source-to-sink tracking of renewable electricity production and associated environmental credit generation and management. A non-exclusive list of examples are the following:

For all entities involved in the pathway, registration information with the appropriate agency may need to be checked and any needed updates are to be performed regularly.

Electricity sale and purchase agreements between parties involved in the pathways are to be recorded and their execution may need to be continuously tracked.

Electricity meter data may need to be recorded continuously. Various checks and calculations may need to be performed using the meter data. For any pathway, this data may include readings of up to several hundred EV stations, which have to be evaluated individually and on an ongoing basis.

For some pathways tracking of feedstock production and delivery is required for the generation of renewable fuel credits (e.g. biogas injected into common carrier pipelines). Source-to-sink tracking of renewable electricity and associated credits based on these pathways may need extension of the tracking system to cover sale agreements, feedstock transportation monitoring from the feedstock source to the renewable electricity producer and several additional requirements as detailed in this document.

In order to demonstrate that renewable electricity was used as transportation fuel and qualifies for renewable fuel credits generation, continuous data collection for electricity sold as transportation fuel at the power plant and EV stations may be necessary. Identification of the end users of renewable electricity and collection of documents demonstrating its qualifying use may also need to be achieved by the tracking system.

Various checks and adjustments may need to be performed on data collected for the tracking of renewable electricity and associated renewable fuel credits when it is processed in order to ensure appropriate generation and transactions of renewable fuel credits.

As part of several cap and trade programs, quality assurance frameworks may be in place to ensure the integrity of renewable fuel credits. Participation in these quality assurance frameworks may be mandatory or optional depending on the individual cap and trade program, but renewable electricity producers may only achieve maximal market value for their renewable fuel credits through successful participation in these quality assurance frameworks. Requirements of these frameworks may go beyond those of the respective regulations and thus any successful, comprehensive solution for the generation, management and tracking of these credits may need to be able to satisfy additional data collection, processing and reporting demands of the quality assurance frameworks.

In addition to the complexity of data evaluation, manual collection of the data may be unfeasible due to the high number of parties involved in any pathway. Power plants, electricity transmission and distribution system operators, EV stations etc. may be different entities within each pathway and geographically spread out (distances of several thousand miles are not uncommon); thus data collection is only possible through the use of an automated aggregation platform.

Due to the high quantity of data and documentation to be collected, methods and system solutions for remedial action in case of an error are essential. These constitute one of the most complex problems involved in ongoing source-to-sink tracking of renewable electricity generation. For example, reconciliation of production over-reporting involves recalculating renewable fuel credit generation and environmental attributes matching for all following days and ultimately may result in the need of invalidating previously generated renewable fuel credits and reassigning electricity transportation to different entities. These processes can only be performed on a database-scale using automated algorithms.

Source-to-sink tracking of renewable electricity production and environmental credit generation may involve recording and aggregation of commercially sensitive data. Furthermore, several independent commercial entities may be involved in the generation and trade of renewable fuel credits, creating the need for redaction of certain data or documentation. For example, a RIN (renewable identification number) buyer will often require assurance that the credits it is looking to purchase are not fraudulently generated—especially if purchasing from a RIN-generator that it has no previous experience with. Providing assurance for the validity of renewable fuel credits may involve granting the buyer access to data and documentation supporting their generation. Any commercially sensitive information from data made accessible to commercial entities for review purposes needs to be redacted. However parts of the redacted information may need to be made accessible to government entities for compliance purposes. Thus a tracking and verification system should be able to dynamically adjust redaction of data based on the entity accessing the information. This cannot be accomplished manually.

Various types of transactions can and need to be performed with renewable fuel credits after their generation. The types of transactions vary between cap and trade programs and may include transfer of ownership, separation from the physical fuel, retirement against the regulated party's obligation, etc. While these transactions are often performed using the appropriate agency's online computer-based platform (hereinafter “environmental credit administration system”), data requirements and administrative burden of registering each of them can be substantial. Furthermore, renewable fuel credits may need to be tracked after generation (e.g. as part of a quality assurance framework's requirements or for establishing the comprehensive credit portfolio of a producer) and data may not only need to be submitted to the appropriate agency's online system, but information such as historical credit inventory for example may need to be imported from the appropriate regulatory databases. Accordingly, advanced tracking of renewable fuel credits may necessitate integration of the online platform with the systems used for regulatory credit administration.

All compliance data may need to be warehoused for up to and potentially exceeding ten years in a manner that is accessible and auditable without delay by the appropriate agency.

Since renewable fuel credits generated for renewable electricity are of significant commercial value, the ability to successfully generate revenue from renewable fuel credits may be essential for the commercial success of renewable electricity applications. Further, source-to-sink tracking of renewable electricity and associated renewable fuel credits can be relatively complex.

### BRIEF DESCRIPTION OF THE DISCLOSURE

Embodiments of the disclosure can address some or all of the above needs. Certain embodiments of the disclosure can provide systems and methods for tracking renewable energy credits. The disclosure relates to systems and methods for the generation and tracking of renewable fuel credits, including renewable identification numbers (RINs), credits under the Low Carbon Fuel Standard (LCFS), and any other credits that may be generated when using renewable electricity (hereinafter “renewable fuel credits”) in a transportation vehicle, including cars, trucks, trains, buses, off-road vehicles, or any other type of transportation vehicle as defined under certain governmental agency guidelines (hereinafter “transportation vehicle”). More particularly, the disclosure relates to the methods and automated, online system used for matching renewable fuel credits back to the individual steps of the renewable electricity generation, distribution and usage pathway—on a source-to-sink basis. Furthermore, certain embodiments of the disclosure can provide automated solutions for management and verification of renewable fuel credits that are generated from the use of renewable electricity in transportation vehicles or other qualifying applications (hereinafter “transportation fuel”).

One or more embodiments of the disclosure can be used to facilitate the registration process of entities involved in the generation of renewable fuel credits with the appropriate agency.

One or more embodiments of the disclosure can be used to collect, organize and track fulfillment of renewable electricity sale agreements. In this implementation, the output of the system would be information for compliance purposes on fulfillment of electricity and gas sale agreements.

One or more embodiments of the disclosure can be used to establish and demonstrate existence of one or more physical transportation path(s) between feedstock sources, renewable electricity generators and EV charging stations. Certain implementations of the disclosure may produce auditable reports on the availability of physical transportation between entities of the pathway that may be backed by third party documentation including, but not limited to, electric power delivery statements.

One or more embodiments of the disclosure can be used to track environmental attributes during renewable electricity generation, transmission and its usage in transportation vehicles.

One or more embodiments of the disclosure can track environmental attributes for transactions between feedstock suppliers and renewable electricity production facilities.

One or more embodiments of the disclosure can be used to collect and organize parts or all information needed for the source-to-sink tracking of renewable electricity and associated environmental credit generation.

One or more embodiments of the disclosure can be used to automate or facilitate the process of renewable fuel credits generation, transactions and reporting through integration with the environmental credit administration system(s) of appropriate agencies.

One or more embodiments of the disclosure can be used to create a comprehensive compliance tool for the generation, verification and portfolio management of renewable fuel credits.

In at least one embodiment of the disclosure, a system can be provided. The system can include at least one processor. The system can also include at least one memory comprising computer-executable instructions. When the computer-executable instructions are executed by the at least one processor, the instructions cause the at least one processor to receive data associated with renewable electricity generation by at least one power plant, receive data associated with renewable electricity usage by at least one electric vehicle station, and based at least in part on the received renewable electricity generation data and renewable electricity usage data, determine one or more renewable energy credits associated with the renewable electricity generation.

In another embodiment of the disclosure, a computer-implemented method can be provided. The method can include receiving data associated with renewable electricity generation by at least one power plant; receiving data associated with renewable electricity usage by at least one electric vehicle station; and based at least in part on the received renewable electricity generation data and renewable electricity usage data, determining one or more renewable energy credits associated with the renewable electricity generation, wherein one or more of the above operations is performed by at least one computer processor.

In yet another embodiment of the disclosure, a non-transitory computer-readable medium storing computer-executable instructions can be provided. The instructions, when executed by one or more processors, can cause the one or more processors to receive data associated with renewable electricity generation by at least one power plant; receive data associated with renewable electricity usage by at least one electric vehicle station; and based at least in part on the received renewable electricity generation data and renewable electricity usage data, determine one or more renewable energy credits associated with the renewable electricity generation using one or more algorithms to match a specific mass, energy, and volume flow of a particular transaction to one or more corresponding renewable fuel credits.

One or more embodiments of the disclosure can have other aspects, elements, features, operations, and/or acts in addition to or in place of what is described above. These potential additions and replacements are described throughout the rest of the specification.

### BRIEF DESCRIPTION OF THE DRAWINGS

Reference will now be made to the accompanying drawings, which are not necessarily drawn to scale, and wherein:

FIG. 1 gives an overview of an example renewable electricity and associated renewable fuel credit generation process, according to one or more embodiments of the disclosure.

FIGS. 2A and 2B provide an overview of an example data flow model for a renewable electricity and associated renewable fuel credit tracking system and process according to one or more embodiments of the disclosure.

FIG. 3 illustrates an example system for tracking renewable energy credits in accordance with one or more embodiments of the disclosure.

FIG. 4 introduces an example tracking system architecture representing a suitable technical implementation of the online system platform—as an embodiment of the disclosure—for source-to-sink tracking of renewable electricity and associated renewable fuel credits.

FIG. 5 depicts a process flow diagram illustrating an example method for tracking renewable energy credits, in accordance with one or more example embodiments of the disclosure.

FIG. 6 illustrates an example tracking algorithm for various systems and methods for tracking renewable energy credits, in accordance with one or more example embodiments of the disclosure.

FIG. 7 illustrates another example tracking algorithm for various systems and methods for tracking renewable energy credits, in accordance with one or more example embodiments of the disclosure.

FIG. 8 illustrates another example tracking algorithm for various systems and methods for tracking renewable energy credits, in accordance with one or more example embodiments of the disclosure.

### DETAILED DESCRIPTION

Described embodiments relate generally to systems and methods for tracking renewable energy credits. This disclosure may, however, be embodied in many different forms and should not be construed as limited to the embodiments set forth herein; rather, these embodiments are provided so that this disclosure will be thorough and complete, and will convey the scope of the disclosure.

As used herein the terms, “environmental credit”, “credit”, and their respective pluralized forms can be used interchangeably within this disclosure.

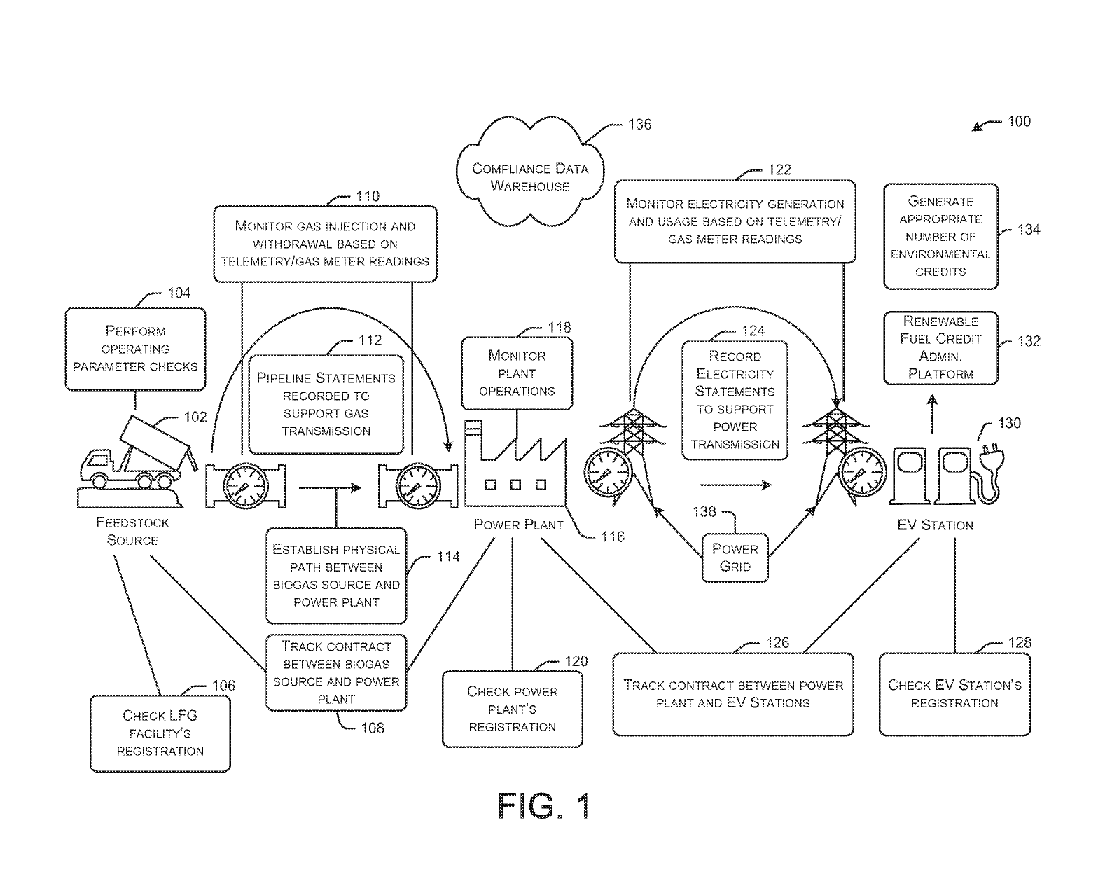

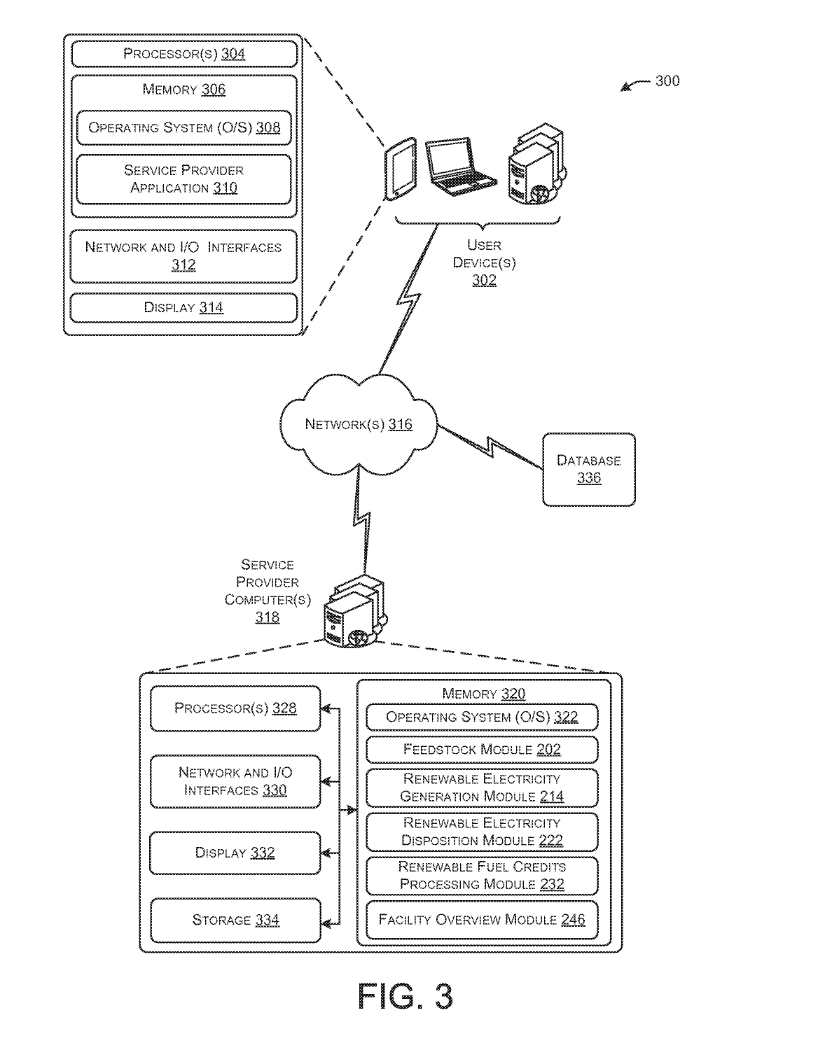

FIG. 1 depicts a simplified flow chart illustrating modules of an example process 100 for electric vehicle (EV) credit generation for tracking renewable energy credits, in accordance with an embodiment of the disclosure. More specifically, the process 100 is a sample pathway of landfill gas to renewable electricity. Certain embodiments of the disclosure can enable non-feedstock specific source-to-sink tracking of renewable electricity and associated renewable fuel credits. While a biogas-specific example is illustrated in FIG. 1, other embodiments and/or implementations of the disclosure, such as non-biogas, can be adjusted to the tracked pathway as well as the commercial and regulatory entities involved. The process 100 described in FIG. 1 can be implemented with respect to a tracking system, such as 300 in FIG. 3.

The “feedstock source” 102 facility shown in FIG. 1 may be any producer of feedstock used in the generation of renewable electricity who satisfies certain applicable regulatory requirements and may or may not be required to register with an appropriate governmental agency. Operational parameters, feedstock production and other activities of this entity may need to be tracked. Feedstock sources for renewable electricity generation may include, but are not limited to, biogas, biomass, liquid biofuel collection, production and processing facilities. Power plant 116 may be any agency-approved producer of renewable electricity who may need to be registered with the appropriate agency for the generation of renewable fuel credits. Facilities referred to hereinafter as power plants 116 may include, but are not limited to, wind turbines, photovoltaic power stations, combined cycle power plants, facilities for cogeneration of heat and power, etc. An EV station 130 can be any entity who directly distributes the renewable electricity to be used as transportation fuel. EV stations 130 may include, but are not limited to, electric vehicle recharging stations, powering stations and infrastructure of trolley busses, electric trains and trams, etc.

Some or all of the feedstock source 102, power plant 116, and EV station 130 facilities may be needed to register under certain renewable fuel credit programs, and certain embodiments of the disclosure can be used to facilitate the registration process. Implementations of the disclosure can be used to facilitate registration data collection of the registrants by providing comprehensive, interactive lists and descriptions of the necessary data and documentation as well as by providing a detailed interface or automated process for registration data input (e.g. check LFG facility's registration 106, check power plant's registration 120, and check EV stations registration 128). Data registered in the tracking system, such as 300 in FIG. 3, may be used for registration with more than one regulatory entity, thus decreasing redundancies in registration data retrieval and submittal by the registrant.

Certain embodiments of the disclosure can be used to provide infrastructure for online storage of the registration data and add active reminders to any registration components that may need regular updates. In one implementation, registered users of the system may receive notifications of necessary updates before they are due. For this implementation, a database of scheduled notifications may be established on the system's servers. Scheduled notifications may be created manually as well as automatically by the system, based on previously established rules. For example, the system may automatically schedule and send out a notification to facilities that an updated engineering review is to be submitted to the appropriate agency six months in advance of the submittal's deadline. Notifications may be received by users via the tracking systems user interface, e-mail, telephone, fax, written mail or any other communication modality. Automatically or manually generated notifications may be used not only in connection with registration information updates; instances initiating scheduled or one-time notifications sent out to the users of the system may include, but are not limited to, events in connection with continuous data submission from facilities (including but not limited to meter readings); regular submission of operating parameters; renewable electricity or feedstock contract tracking; renewable fuel credit generation and portfolio reports; regulatory changes; any remedial action that needs to be taken by the user; etc.

Certain embodiments of the disclosure can be used to run checks on the operating parameters of feedstock sources 102, power plants 116, and EV stations 130 as shown in FIG. 1. Necessity and the exact nature of operating parameter checks 104 to be performed may be dependent on the specific pathway for renewable electricity generation and the applicable regulatory and quality assurance requirements. Operating parameter checks 104 may include, but are not limited to, monitoring and comparison of fuel usage versus the product output of the facility (e.g. comparison of utility bills with production); automated or manual checks that ensure that the facility does not exceed its production, storage, feedstock utilization, transportation or other permitted capacity registered with the appropriate agency; checks determining whether the facility is appropriately staffed for its operations; surveillance or audit ensuring that the facility operates according to its current registration; product sampling programs to ensure that the production meets the applicable specifications. Operating parameter checks 104, and the evaluation, processing, reconciliation, storage and other operations performed on the data generated by these checks, may be executed using certain embodiments of the disclosure. Implementations of the tracking system may be configured to monitor operational parameters of the facilities and register an event when they fail to match sets of predefined criteria. For example, production of a facility exceeding its registered maximum nameplate capacity could create an event that may trigger several routines or processes that run on the tracking system's servers. The processes triggered may include, but are not limited to, notifications sent out to the facility or the system operator, log creation on the failed check, suspension of renewable fuel credits generation for that pathway, revision of the facility's operational history and adaptive assessment of the failed check based on historical events, etc.

Certain embodiments of the disclosure may be used to perform and facilitate operating parameter checks which cannot be based on automated or regular data submission by the facilities, but instead may need personal audit programs. Frameworks may be created for each type of audit program containing audit requirements, audit procedure descriptions and infrastructure for communication and data transfer between those involved. Implementations of the disclosure may be used to provide digitalized auditing tools which are available on a handheld device—including, but not limited to, tablets, smartphones, laptops, palmtops, dedicated devices, wearable computers, etc.—at the disposal of the person performing the audit program steps on site. This could be substituted or complemented by an audit report interface of the system that can be accessed by the person performing the onsite and desk audit steps using any device capable of displaying webpages or running dedicated software. The audit report interface may enable input of audit data directly into the system with the opportunity for partly or fully automated operating parameter checks.

As shown in FIG. 1, certain embodiments of the disclosure may be used to track generation of renewable electricity, furthermore—if necessary—feedstock used for renewable electricity generation. Renewable electricity production of the power plant 116 may be tracked through continuous recording of power meter data (e.g. monitor plant operations 118, monitor gas injection and withdrawal based on telemetry/gas meter readings 110, and monitor electricity generation and usage based on telemetry/gas meter readings 122). Recording of renewable electricity production meter data may be achieved through several data collection methods including, but not limited to, real-time integration of the online tracking system's database with the power plant's 116 or other entity's data monitoring and storage system enabled by an application programming interface or any other method or standard allowing for the transfer and migration of the power plant's 116 production data to the tracking system's database; regular manual or automated data submission by the power plant 116 or any other entity recording the renewable electricity generation which can be facilitated by automated or manual data transfer and import solutions including, but not limited to, manually editable spreadsheet templates (e.g. Microsoft Excel® or comma separated value (CSV) files) that may be manually or automatically imported to the tracking system's database; a dedicated interface—that may be web-based, part of a dedicated software or any other interfacing solution running on a desktop computer, smartphone, tablet or any other device—allowing for manual or automated input of data including but not limited to production numbers by the power plant 116; manual or automated alternative solutions for regular data collection such as verbal reporting via telephone, VoIP (Voice Over IP Protocol) or any other solution allowing for verbal telecommunication; furthermore written reporting of production numbers via e-mail, facsimile, mail or any other solution for written telecommunication. Received production data may be imported to the tracking system's database using manual or automated algorithms or custom methods. Submitted data may be checked using manual or automated data validation methods to filter out omissions, inappropriate formatting, incompleteness, inconsistency and any other errors or flaws that could compromise correctness, meaningfulness, and security of data that are input to the system. Data relevant to renewable electricity generation may be stored on the tracking system's servers and used in the downstream tracking process. As shown in FIG. 1, the data relevant to renewable electricity generation, could be, but is not limited to, pipeline statements recorded to support gas transmission 112, contracts between biogas source and power plant 108, record of electricity statements to support power deliveries 124, and contracts between power plant and EV stations 130.

Certain embodiments of the disclosure can be used to track delivery of renewable electricity and—if needed—feedstock used for renewable electricity generation as shown in FIG. 1. Renewable electricity delivery tracking may be necessary if renewable electricity is used off-site and thus needs to be transferred using the power grid, a dedicated electric power transmission system or other means.

Certain embodiments of the disclosure may be used to track renewable electricity introduced into a dedicated electric power transmission system through continuous recording of meter data of electricity introduced into and used from the power transmission system. Documentation of agreements for the sale of renewable electricity between the power plant 116, the purchaser of the electricity, and the EV station 130 may be retained in the tracking system. Certain embodiments of the disclosure may be capable of tracking execution of renewable electricity sale and purchase agreements by matching the tracked renewable electricity deliveries with the contracted quantities specified in the agreements. The physical pathway used for the transfer of renewable electricity in a dedicated electric power transmission system, such as a physical path 114 established between a biogas source and power plant, may be established and appropriate data and documentation may be retained in the tracking system. If continuous metering of electricity transfer is needed, introduction of electricity by the power plant 116 into the dedicated power transmission system and usage by the EV station 130 may be reconciled to substantiate fulfillment of the recorded electricity sales agreement.

As shown in FIG. 1, tracking of environmental attributes may be utilized for verification of renewable electricity deliveries and if needed, feedstock used for generation of renewable electricity. In the following, an example is provided for implementation of tracking the transfer of renewable electricity that is introduced into a power grid, utilizing environmental attributes. The below scenario is not meant to provide an exclusive description of the disclosure's applicability but instead demonstrates that certain embodiments of the disclosure may provide means for reliable and flexible tracking of renewable electricity through the use of environmental attributes across a wide range of practical implementations.

Upon successfully demonstrating the physical transportation path between the power plant 116 and the EV station 130, and the contractual relationship for the purchase and sale of environmental attributes associated with renewable electricity between the power plant 116 and the EV station 130; metering of introduction of renewable electricity to the power grid by the power plant 116 and usage of electricity by the EV station 130 may occur on an ongoing basis. Data and documentation on the physical transportation path and contractual relationship between the power plant 116 and the EV station 130 may be retained in the tracking system.

Environmental attributes may be generated based on renewable electricity that is introduced into the power grid on a daily basis. This may be achieved for example by enabling continuous recording of readings taken by the metering system that measures electricity input to the power grid by the power plant 116.

Electricity usage by the EV station 130 may be tracked and recorded on a daily basis, regardless of where the electricity was purchased from. In this manner, environmental attributes associated with sales of electricity by the power plant 116 to a third-party may be matched with acquisition of electricity by the EV station 130 from a separate third-party. It may also be possible to sell environmental attributes to an EV station 130 separate from the renewable electricity to allow the EV station 130 to match (or rebundle) the environmental attributes with electricity they are purchasing from a third-party to represent the fact that renewable electricity was introduced at one point on the power grid and the attributes from that renewable electricity were matched or re-bundled with electricity purchased at another point on the power grid to document the creation and use of renewable electricity for production of transportation fuel.

Renewable fuel credit generation may be based on the quantity of environmental attributes transferred from the power plant 116 to the EV station 130. The power plant 116 may attest to the fact that no other party is making claims to the environmental attributes and that the rights to the environmental attributes are transferred solely to the EV station 130, precluding any other entity from generating renewable fuel credits for these environmental attributes.

The power plant 116 may support a certain quantity of renewable electricity introduced into the power grid and associated environmental attributes with third-party documentation, such as statements or invoices issued by the utility or transmission system operators (e.g. record electricity statements or invoices to support power deliveries 124). Similarly, the EV station 130 may, in some instances, only acquire the environmental attributes associated with the quantity of metered electricity used on any given day.

The tracking system may be able to bank environmental attributes produced and not yet used in order to be used on subsequent days.

In one example embodiment, the compliance data may need to be warehoused for up to and potentially exceeding ten years in a manner that is accessible and auditable without delay by the appropriate agency via a compliance data warehouse.

In one example embodiment, the owner of the EV station 130 can send renewable fuel credit generation data to the renewable fuel credit administration platform 132, in order to generate appropriate number of environmental credits 134.

The operations and elements shown in FIG. 1 are by way of example only. Other embodiments of processes for EV credit generation for tracking renewable energy credits can have fewer or greater numbers of operations and/or elements in accordance with embodiments of the disclosure.

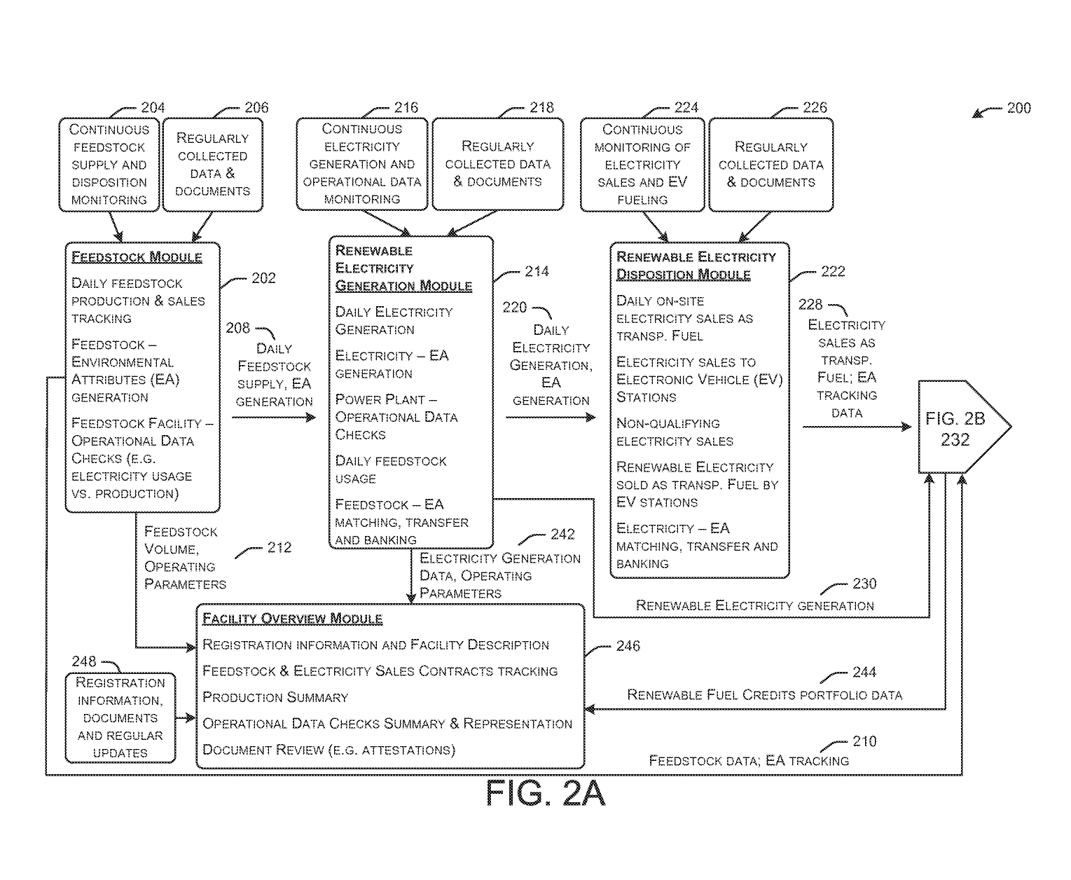

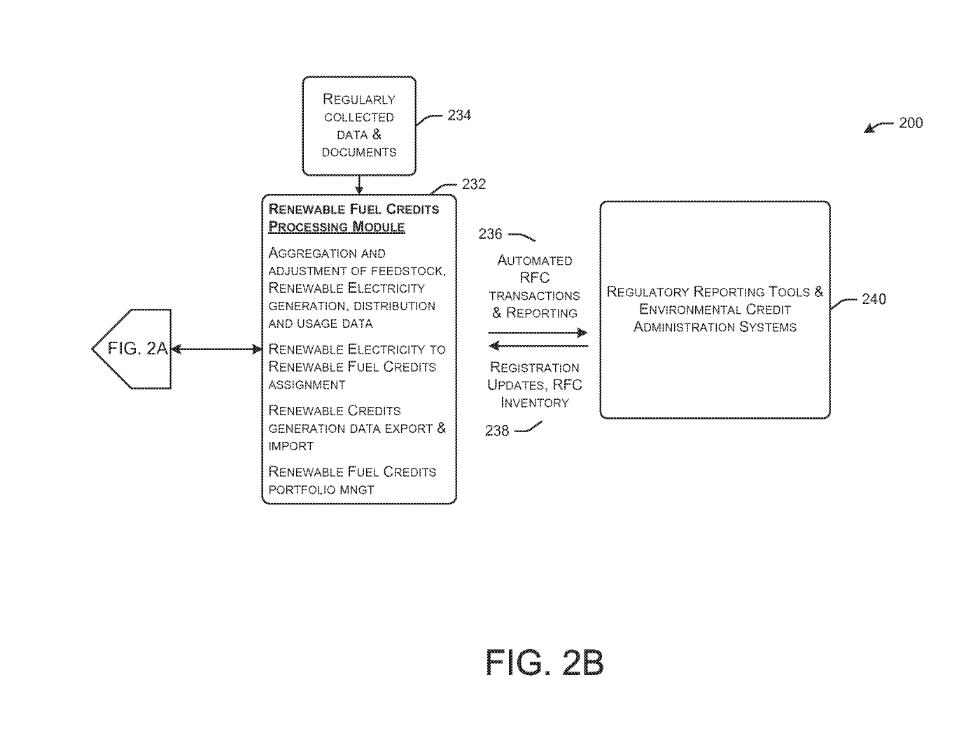

FIGS. 2A and 2B (collectively referred to as “FIG. 2” herein) illustrate an example data flow, according to an example embodiment of the disclosure. The data flow 200 illustrates a data flow model that may be used in an online system for the tracking of renewable electricity and associated renewable fuel credits, such as tracking system 300 in FIG. 3. The identified inputs, outputs and internal data flows described hereunder do not represent the exclusive applicability of the disclosure but are intended to give an example of how embodiments of the disclosure may be utilized in the creation of a platform solution for tracking of renewable electricity and associated renewable fuel credits. Furthermore, operations of the data flow 200 illustrated in FIG. 2 may be altered, extended or omitted depending on the pathway of renewable electricity that is to be tracked. The individual modules and functional units of the data flow 200 can be segregated in FIG. 2 for demonstration purposes only and to facilitate description of the individual processes within a tracking system for renewable electricity and associated renewable fuel credits. Various embodiments of the disclosure may be implemented using a wide range of data flow and processing architectures.

If tracking of feedstock used for the generation of renewable electricity and associated renewable fuel credits is necessary, a feedstock module 202 may be part of the verification system—as shown in FIG. 2A. Continuous feedstock supply and disposition monitoring 204 of the power plant, such as 116 in FIG. 1, may be examined through regularly collected data and documents 206 from feedstock suppliers, the power plant 116 itself or any third party data source. Data and documentation 206 collected for the tracking of feedstock supply and disposition 204 may include, but is not limited to, meter readings and telemetry, inventory levels, purchase and sale agreements, product transfer documents, invoices, bills of lading, weigh tickets, utility bills, etc. The primary output of the feedstock module 202 may include, but is not limited to, the aggregated quantity of qualifying daily feedstock procurement (during any period) and environmental attribute generation 208. Daily feedstock procurement is given as an example for the scope of data aggregation. This output may be used in downstream tracking procedures in order to provide assurance that renewable electricity is generated from qualifying feedstock and applicable requirements for the validity of renewable fuel credits are satisfied. In addition to generating the outputs used in consecutive tracking procedures, the feedstock module 202 may also be used to establish records of the supporting documentation that substantiates the feedstock data. Supporting documentation that is stored on the tracking system's servers or any other data repository that is accessible by the tracking system may be referenced in records created in the feedstock module 202, creating a connection between the feedstock data used in the tracking system and the supporting documentation that allows for verification of the data. By assigning documentation to data that is processed in the system, supporting documentation may be retrieved even after feedstock data has been transferred to and potentially modified in other modules or systems. This may ensure that recordkeeping requirements of renewable electricity and associated renewable fuel credit generation are suitably satisfied at specific or all times. Methods of tracking feedstock supply may include monitoring of feedstock received by the power plant 116 directly from any feedstock source, such as 102 in FIG. 1, or tracking of feedstock through the use of environmental attributes. Data collected on the feedstock source's 102 activities may be used to perform operation parameter checks, such as 104 in FIG. 1.

As seen in FIG. 2A, the renewable electricity generation module 214 may be used to process the data necessary for keeping track of renewable electricity generation. Inputs of this module 214 may include, but are not limited to, continuous electricity generation and operational data monitoring 216 and regularly collected data and documents 218, such as meter readings and telemetry from the power plant 116 or other facilities, inventory levels, purchase and sales agreements, product transfer documents, invoices, utility bills, information acquired during personal audits, regulatory registration information, etc. In certain embodiments of the disclosure, inputs of the renewable electricity generation module 214 may include continuously registered data feeds (including, but not limited to, power meter telemetry or information feeds from the power plant's operational control system) as well as data registered regularly in certain intervals (including, but not limited to, power grid operator's monthly statements). Supporting documentation collected to substantiate operational data of the power plant 116 may be assigned to the corresponding data so that it may be easily retrieved after processing and transfer to different modules or systems. If tracking of feedstock is necessary, the power plant's 116 generation is recorded and matched with feedstock data using the output of the Feedstock Module 202. Matching of feedstock supply with renewable electricity generation 230 (as sent to the renewable fuel credits processing module 232) may either be accomplished using quantities of feedstock received directly by the power plant 116 or by tracking environmental attributes generated for feedstock (e.g. feedstock data; environmental attributes tracking 210). In either case, certain embodiments of the disclosure may be capable of assigning feedstock procurement to renewable electricity generation in order to ensure that regulatory requirements regarding feedstock acquisition and tracking for the generation of renewable electricity are met. If necessary, assignment of feedstock procurement to renewable electricity generation may go beyond checks performed to assure that the quantity of procured eligible feedstock is sufficient to cover the amount of renewable electricity generated in any given period and may allow for identification of the exact quantity and source of feedstock procurement connected to a given unit of renewable electricity production. Thus, for example, certain embodiments of the disclosure may allow for identification of documentation supporting the procurement of feedstock assigned to the renewable electricity generation of a given day. In certain embodiments of the disclosure, checks on the operational data of the power plant 116 may be performed by the renewable electricity generation module 214 or other parts of the tracking system. If the renewable electricity generation pathway does not allow for direct tracking of renewable electricity transportation (e.g. renewable electricity is transmitted to the buyer via the power grid instead of a dedicated system or on-site usage), environmental attributes may be created in the renewable electricity generation module 214 for the volumes of renewable electricity generated. In addition to creating the environmental attributes from the tracking of renewable electricity deliveries, any supporting documentation that is necessary—including, but not limited to, attestations supplied by the power plant 116 or any other party ensuring the validity and correct usage of environmental attributes—may be recorded and assigned to the environmental attributes upon creation. The output of the renewable electricity generation module 214 that is used in further tracking steps may include, but is not limited to, the aggregated renewable electricity generation quantity of any given period, as well as references to any supporting documentation (e.g. daily electricity generation, environmental attributes generation 220).

As seen in FIG. 2A, certain embodiments of the disclosure may be used to track disposition of generated renewable electricity. The inputs of the renewable electricity disposition module 222 may include, but are not limited to, renewable electricity generation data 220 from the renewable electricity generation module 214 or other sources, as well as continuous monitoring of electricity, sales, and EV fueling 224 data feeds or regularly collected data and documents 226 on renewable electricity sales. Continuous data feeds 224 may include but are not limited to power meter telemetry of the renewable electricity buyers and users. Regularly recorded information 226 may include, but is not limited to, statements issued by the power grid operators, documentation on the amount of renewable electricity dispensed as transportation fuel, attestation of EV stations on qualifying usage of the renewable electricity, electricity sale and purchase agreements between the appropriate entities. One of the tasks performed in the renewable electricity disposition module 222 may be tracking usage of the produced renewable electricity and determining whether it qualifies for renewable fuel credit generation. In addition to matching renewable electricity generation with its usage by EV stations or other entities—either directly or through the use of environmental attributes—the renewable electricity disposition module 222 can allow for tracking of the renewable electricity's end use, which may be necessary in order to fulfill the regulatory requirements of renewable fuel credit generation. The exact reporting requirements may vary depending on the cap and trade program under which renewable fuel credits are generated, however most regulatory programs require that the renewable electricity is used for qualifying purposes in a given geographic region. The tracking of qualifying use of renewable electricity may be achieved in the renewable electricity disposition module 222 by assigning appropriate attributes to each registered electricity transaction. These attributes can allow for the identification and tracking of on-site sales, deliveries through the power grid, electricity sold as transportation fuel and as non-transportation fuel, renewable electricity sold with or without obligations or credits under the appropriate cap and trade program and other criteria which may be determined by the requirements of the appropriate cap and trade program. The information collected and processed in the renewable electricity disposition module 222 may be used to establish the amount of renewable electricity used for qualifying purposes. Any conversions or additional data processing necessary for the tracking of electricity deliveries may be performed by the renewable electricity disposition module 222. Outputs of the module include, but are not limited to, electricity sales as transportation fuel and environmental attributes tracking data 228, as well as the amount of electricity sold by the power plant 116 for qualifying and non-qualifying usage, necessary adjustments in connection with electricity deliveries and usage, and supporting documentation that allows for verification of the data.

The renewable fuel credits processing module 232 in FIG. 2B can aggregate data generated by all previously described modules of the tracking system and may collect additional information from external sources in order to achieve reliable management of renewable fuel credits generation and tracking. Data input such as regularly collected data and documents 234 to the renewable fuel credits processing module 232 may include, but are not limited to, automated renewable fuel credits transactions and reporting 236, as well as registration data of entities involved in the tracked pathway. This data may be acquired either directly from the regulatory reporting tools and environmental credit administration systems 240 as registration updates and renewable fuel credits inventory 238 and used for tracking and administration of renewable fuel credits transactions by the regulatory authorities (hereinafter referred to as “renewable fuel credits transaction systems”), or from alternative data sources such as manual or automated data and documentation input on renewable fuel credit transactions by the power plant 116 or any other entity. Certain embodiments of the disclosure may be able to directly interface or facilitate data entry and export from the renewable fuel credits transaction systems. This may be achieved by certain embodiments of the disclosure through adaptation of data transmission protocols used by the renewable fuel credits transaction systems in communications with external systems. If the tracking system is capable of interfacing with the renewable fuel credits transaction systems, a full integration of source-to-sink renewable electricity and associated renewable fuel credits management may be achieved. Certain embodiments of the disclosure may be capable of interfacing with renewable fuel credits transaction systems may fully automate generation and transaction of renewable fuel credits portfolio data 244, possibly eliminating or minimizing manual data management and reporting of renewable fuel credit transactions. Automated interfacing between the tracking system and the renewable fuel credits transaction systems may not always be feasible or desirable due to a number of reasons, thus certain embodiments of the disclosure may not have this capability. In this case, certain embodiments of the disclosure may be able to facilitate reporting of renewable fuel credit transactions and data input into the renewable fuel credits transaction systems. This may be achieved through data input interfaces which allow the entity reporting renewable fuel credit transactions to easily identify, lookup, register, aggregate, verify and submit data and documentation needed for appropriate reporting of transactions. Facilitation of reporting activities may be achieved in several ways, including but not limited to simplified data input interfaces, descriptions, automated population of certain or all data requirements and conversion utilities capable of formatting available data so that it may be easily submitted for satisfying reporting requirements.

Data used for renewable fuel credits reporting may be created and made available in the renewable fuel credits processing module 232 in FIG. 2B. In order to satisfy the reporting requirements of particular renewable fuel credit programs, certain embodiments of the disclosure may be capable of integrating and evaluating data generated in the tracking system or acquired from external sources in order to produce data output that may be utilized in the management of renewable fuel credits. In order to determine and substantiate the amount of credits to be created, the renewable fuel credits processing module 232 may aggregate and assign mass, energy and volume flows established in the previously described modules of the tracking system (including but not limited to feedstock production and procurement; renewable electricity generation, sales, delivery and usage information, environmental attributes transactions—hereinafter referred to as “recorded transactions”) to the renewable fuel credits generated. This effectively establishes the genealogy of the renewable fuel credits through assigning recorded transactions; as well as additional data elements—including, but not limited to, contracts, sale and purchase agreements between involved parties, registration information, attestations, third party audit reports, information on the various checks performed on the data—to the volume of renewable fuel credits generated or transacted. Certain embodiments of the disclosure may assign supporting documentation (including, but not limited to contracts, third party statements, verified telemetry data, metering reports, bills of lading, weigh tickets, etc.) to recorded transactions. Since recorded transactions are used to establish the data used for renewable fuel credits generation and transactions, the genealogy of the renewable fuel credits established in the renewable fuel credits processing module 232 can allow certain embodiments of the disclosure to provide a relatively high level of assurance regarding the validity of renewable fuel credits generated and transacted.

The assignment of recorded transaction and additional information to volumes of renewable fuel credits in the renewable fuel credits processing module 232 can be performed through a series of one or more algorithms that can provide assurance that few or no inconsistencies exist within the recorded transactions and that renewable fuel credits are only generated for physical production and qualifying usage of the fuel. Certain embodiments of the disclosure may achieve this by establishing mass, energy and volumetric balances. Algorithms used for the creation of renewable fuel credits generation and transaction data aggregate recorded transactions that are not yet assigned to renewable fuel credits, and thus, used for their generation. The volumetric, mass or energy flows of the recorded transactions to be used in the creation of renewable fuel credits generation and transaction data can be checked for consistency. Checks may include, but are not limited to, providing assurance that: enough feedstock has been procured to support the amount of renewable electricity generated; the amount of renewable electricity reported as sold is consistent with its generation; amount of environmental attributes used at receipt point of renewable electricity is consistent with their generation; etc. After balances of the registered transactions are successfully established, the amount of renewable fuel credits that may be generated can be calculated. Certain embodiments of the disclosure may check and adjust the volume of renewable fuel credits generation in accordance with factors including, but not limited to, ineligible feedstock quantities which may cause part of the renewable electricity to be ineligible for renewable fuel credits generation; necessary adjustment of the quantity of eligible fuel in order to ensure that the conversion to renewable fuel credit-equivalents satisfies certain regulatory requirements; providing assurance that no credits are generated for quantities of renewable electricity which were generated or sold in a manner that is inconsistent with their qualifying usage or feedstock procurement; no renewable fuel credits are generated for quantities of renewable electricity that are not covered by an appropriate contract or sale agreement between the involved parties, no renewable fuel credits are generated for quantities of renewable electricity for which qualifying usage cannot be appropriately established; etc. After establishing balances and appropriately adjusting quantities, certain embodiments of the disclosure may establish the genealogy of generated renewable fuel credits through assigning the appropriate registered transactions to the credits. Registered transactions that are assigned to a quantity of renewable fuel credits are not used in subsequent renewable fuel credits generation events, thus precluding double-generation of credits for renewable electricity generation and usage tracked by the system. Assignment of recorded transactions to renewable fuel credits may be performed using various approaches, including but not limited to, a first in first out system (“FIFO” hereinafter). If the FIFO approach is utilized in at least one practical implementation of the disclosure, unassigned recorded transactions can be assigned to renewable fuel credits in a chronological order. This may be accomplished by sorting each transaction in a chronological order by type. For each type of chronologically sorted recorded transactions, a quantity (e.g. feedstock procured. MWHs (megawatt hours) of renewable electricity generated, etc.) established based on the previously established volumetric, mass and energy balances is selected for assignment to the generated renewable fuel credits. Certain embodiments of the disclosure may include partly or completely redundant checks to ensure that assignment of registered transaction to renewable fuel credits does not result in inconsistencies (these may include, but are not limited to, an unreasonably or unacceptably long lag between the different steps of the tracked processes, such as renewable electricity generation and qualifying usage).

Certain embodiments of the disclosure may apply a system of checks and balances to ensure appropriate generation and transaction of renewable fuel credits. In case one or more of the checks and balances established by the system is not satisfactory, generation of renewable fuel credit may not proceed until the issue is resolved. Each failed check or misbalance that cannot be corrected automatically may result in triggering one or more events that lead to logging the problem discovered, notifying one or more appropriate stakeholder or other actions. Certain embodiments of the disclosure may include appropriate display and interfacing functions that facilitate corrective actions that are to be taken to resolve issues discovered through automated checks and balances or other means. After the necessary corrections, modifications, data input or other necessary actions have been performed by the appropriate stakeholders, the system of checks and balances is re-applied to the corrected data—resulting either in successful generation of data needed for renewable fuel credits generation or an event triggered by any unresolved issues.

Some or all modules shown in FIG. 2 may be capable of performing remedial actions. Causes for remedial actions may be, but are not limited to, data input errors, information discrediting data that was registered in the tracking system and was unknown at the time of data input, a regulatory change in renewable electricity and associated renewable fuel credits tracking and reporting requirements, etc. Changes in the registered and processed data may require recalculation of the tracked processes, as well as remedial reporting actions towards the appropriate agencies. Since tracking of renewable electricity and associated renewable fuel credits can be accomplished by certain embodiments of the disclosure through establishing mass, energy and volumetric balances of the recorded transactions, changes in one segment of the tracking data may need adjustment of the entire data set that is connected to that entry. The following, non-exclusive scenario illustrates the need for remedial actions and their consequences: a volume of feedstock is deemed ineligible for generation of renewable fuel credits, after renewable fuel credits generation is already established by the renewable fuel credits processing module 232 and thus the discredited feedstock acquisition and usage transactions are already assigned to the respective volume of renewable fuel credits. If a volume of feedstock is discredited, all subsequent processes connected to that volume (e.g. renewable electricity generation from that volume of feedstock) are affected and need to be reconciled. The tracking system needs to be able to establish mass, energy and volumetric balances throughout the entire tracked pathway through retrospectively adjusting records in accordance with the changed conditions. In the example of a discredited volume of feedstock, qualifying and consistent feedstock procurement may need to be reassigned to the affected renewable electricity and renewable fuel credit quantities and may result in the need to adjust the volume of credits already reported and generated. Furthermore, if the tracked pathway involves environmental attributes assignment and usage of environmental attributes may need to be reevaluated and checked for consistency. Due to the various balances that may be established by certain embodiments of the disclosure, these procedures are fairly complex and may necessitate integrative data management of all affected databases and modules of the system. Thus, certain embodiments of the disclosure may be equipped with automated or manual algorithms capable of reliably performing remedial actions in case of changes in the data registered and processed in the tracking system.

The facility overview module 246 shown in FIG. 2A may be used in certain embodiments of the disclosure to aggregate, organize, display and provide easy access to facility-level information. Data inputs of the facility overview module 246 may include, but are not limited to, data processed in other modules of the tracking system (e.g. the feedstock volume and operating parameters 212 from the feedstock module 202, electricity generation data and operating parameters 242 from the renewable electricity generation module 214, renewable fuel credits portfolio data 244 from the renewable fuel credits processing module 232, etc.); as well as facility or company-level information and documentation on entities associated with the tracked pathway, collected from external sources (e.g. registration information, documents and regular updates 248). Information processed in the previously described and any additional parts of the tracking system that is made available for review in the facility overview module 246 includes but is not limited to information on following: feedstock procurement; renewable electricity generation; renewable electricity sales and usage; renewable fuel credits generation, sale and current availability; any other information and documentation collected for the tracking of the renewable electricity pathway; checks performed on the involved entities' operating parameters and recorded transactions including but not limited to those discussed in the above. Information collected from external sources and processed in the facility overview module 246 may include, but is not limited to following data and documentation on entities involved in the tracked pathway: regulatory registration information; company and facility-specific descriptive information and documentation (e.g. IRS form W9, Certificate of Formation, Certificate of Registration, list of company's major shareholders); water, construction and operating permits; attestations; third party and internal reviews; utility bills and usage information; sales contracts for goods and services pertinent to the tracked pathway; sales reference information. The registration information, documents and regular updates 248 may be processed by the facility overview module 246 in order to produce information that facilitates review and verification of the entities involved in the tracked pathway. Documentation supporting verification of the tracked pathway may be made available in the facility overview module 246 in an organized and relatively easy to review fashion.

Certain embodiments of the disclosure may use the facility overview module 246 as one of the main interfacing solutions between the tracking system and parties interested in acquiring information about the tracked pathway, as well as an entry point to additional data retrieval and display services provided by the tracking system. This interface may be made available to users of the tracking system through a web site, web-based application, dedicated program or any other means that allow for display and inquiry of relevant data. Information may be displayed using tables, descriptive text, maps, graphs, illustrations, photographs and any other means that allow for review of the displayed information.

Certain embodiments of the disclosure may be capable of dynamically adjusting the information that is made available to individual users of the system. This may be achieved through a log-in system, which requires identification of the user before providing access to the tracking information stored by certain embodiments of the disclosure. The information and documentation made available to each individual user or a group of users may be dynamically adjusted, enabling review of the pathway by parties to which the entire tracking information shall not be disclosed. Certain embodiments of the disclosure may also have dynamic document redaction capabilities. Documents may be redacted through an appropriate interface by the person inputting the document, as well as other users of the system. Redaction of documents may be performed in a manner that does not directly modify the documentation stored in the system. Instead, document redaction data is stored in the system independently from the documents themselves. This enables adjustment of document redaction when users access documentation through the tracking system. The following is a non-exclusive example of dynamically adjusted redaction of documentation: a renewable electricity sales contract may be saved in the tracking system to demonstrate that the applicable regulatory requirements are satisfied. The entity supplying the documentation may redact pricing and other confidential business information from the document after its input into the system. This can be done through a document redaction tool that allows the user to redact appropriate portions of the document—e.g. by drawing rectangles, obscuring the document below. The redaction data—in this case the rectangle's position—is added as an attribute to the document's record in the system instead of modifying the document itself. When a potential buyer of renewable fuel credits accesses the system, the redacted portions of the document are not made available to him; while a regulatory entity reviewing the document may receive unrestricted access to its content.

The data flow 200 shown in, and described with respect to FIG. 2, is provided by way of example only. Numerous other data flows, operating environments and components, system architectures, and device configurations are possible. Accordingly, embodiments of the disclosure should not be construed as being limited to any particular data flow, operating environment or component, system architecture, or device configuration.

With reference now to FIG. 3, a tracking system 300 for identification verification is shown according to one or more embodiments of the disclosure. The system 300 may include one or more user devices 302 in network and/or direct communication with one or more service providers. In general, the user device 302 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The one or more user devices 302 may include one or more computer processors 304, and a memory 306 storing an operating system 308 and a service provider application 310. In addition, the one or more user devices 302 may include a network and I/O interface 312 and a display 314. In certain embodiments, the one or more user devices 302 may include one or more sensors capable of gathering information associated with a present environment of the respective user device 302, or similar hardware devices, such as a camera, microphone, antenna, a gesture capture or detection device, or Global Positioning System (GPS) device.

The one or more computer processors 304 may comprise one or more cores and may be configured to access and execute (at least in part) computer-readable instructions stored in the memory 306. The one or more computer processors 304 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The one or more user devices 302 may also include a chipset (not shown) for controlling communications between the one or more processors 304 and one or more of the other components of the respective user device 302. In certain embodiments, the one or more user devices 302 may be based on an Intel® architecture or an ARM architecture, and the processor(s) and chipset may be from a family of Intel® processors and chipsets. The one or more processors 304 may also include one or more application-specific integrated circuits (ASICs) or application-specific standard products (ASSPs) for handling specific data processing functions or tasks.

The memory 306 may include one or more computer-readable storage media (CRSM). In some embodiments, the memory 306 may include non-transitory media such as random access memory (RAM), flash RAM, magnetic media, optical media, solid state media, and so forth. The memory 306 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 306 may store an operating system 308 that includes a plurality of computer-executable instructions that may be implemented by the computer processor to perform a variety of tasks to operate the interface(s) and any other hardware installed on the respective user device 302. The memory 306 may also store content that may be displayed by the respective user device 302 or transferred to other devices (e.g., headphones) to be displayed or played by the other devices. The memory 306 may also store content received from the other devices. The content from the other devices may be displayed, played, or used by the respective user device 302 to perform any necessary tasks or operations that may be implemented by the computer processor or other components in the respective user device 302.

In the particular example shown in FIG. 3, a service provider application 310 stored in memory 306 may be configured to interface with a user and provide or otherwise facilitate renewable energy credit tracking functionality to the user. For instance, the service provider application 310 may be operable to communicate with one or more service providers, such as a renewable energy company, renewable energy credit tracking host entity, feedstock source provider, power plant, EV station, etc., and may be in communication with one or more respective service provider computers 318 associated with at least one service provider. As such, the service provider application 310 may enable the user to access information and/or services associated with a respective service provider. For example, the service provider application 310 may enable the user to receive data, such as feedstock production, sales tracking, environmental attributes generation, electricity generation, renewable electricity generation, renewable fuel credits portfolio data, production summary, etc., from any number of service providers operating respective service provider computers 318.

The network and I/O interfaces 312 may also include one or more communication interfaces or network interface devices to provide for the transfer of data between the respective user device 302 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The respective user device 302 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11 n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the respective user device 302 and another device, such as an access point, a host computer, a server, a router, a reader device, and the like. The network may include, but is not limited to, the Internet, a private network, a virtual private network, a wireless wide area network, a local area network, a metropolitan area network, a telephone network, and so forth.

The display 314 may include, but is not limited to, a liquid crystal display, a light-emitted diode display, or other suitable display or output-type device. The display 314 may be used to show content to a user in the form of text, images, or video. In certain instances, the display 314 may also operate as a touch screen display that may enable the user to initiate commands or operations by touching the screen using certain finger or hand gestures.

The one or more user devices 302 may also be in communication with one or more service provider computers 318, such as via one or more networks 316. The one or more service provider computers 318 may include one or more processors 328 and at least one memory 320, which may store an operating system 322, and at least one module (i.e., as shown and also described in FIG. 2, a feedstock module 202, renewable electricity generation module 214, renewable electricity disposition module 222, renewable fuel credits processing module 232, or a facility overview module 246). In some embodiments, one or more of the various modules 202, 214, 222, 232, 246 may be associated with or otherwise hosted by different entities, service providers, and/or service provider computers 318. Furthermore, the one or more service provider computers 318 may include respective network and I/O interfaces 330, a display 332, and storage 334. In some implementations, the one or more service provider computers 318 may be associated with one or more tracking systems.

Furthermore, as shown in the embodiment of FIG. 3, a database 336 can be accessible by the user devices 302 and/or service provider computers 318 via the one or more networks 316. The database 336 can include any type of data storage device and/or any number of data storage devices.

As desired, embodiments of the disclosure may include a system with more or less than the components illustrated in FIG. 3. Additionally, certain components of the system 300 may be combined in various embodiments of the disclosure. The system 300 of FIG. 3 is provided by way of example only.

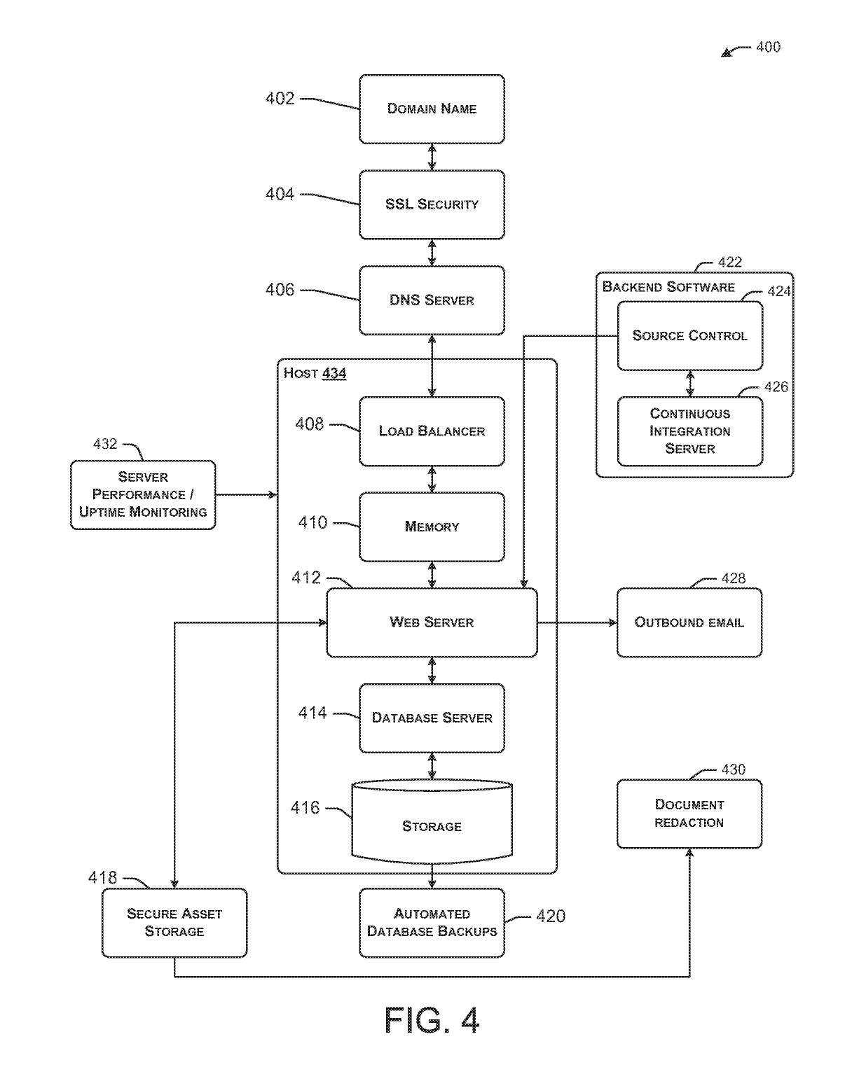

FIG. 4 illustrates an example tracking system architecture 400 for which the process 100, data flow 200, and/or system 300 may be implemented. FIG. 4 provides a conceptual overview of a tracking system architecture for source-to-sink tracking and management of renewable electricity and associated renewable fuel credits. The tracking system architecture 400 is only one example of a suitable computing environment and is not intended to suggest any limitation as to the scope of use or functionality of the disclosure. The disclosure can be operational with numerous other general purpose or special purpose computing system environments or configurations. The tracking system architecture 400 demonstrates one conceptual approach to the practical implementation of the disclosure.

A domain name 402 can be a string that represents an Internet protocol to facilitate access to a web-based tracking system. A domain registrar can be the entity responsible for managing the reservation of a domain name 402. SSL (Secure Sockets Layer) security 404 can be the cryptographic protocol used to securely communicate with a web application or website over the internet and thus necessary to provide secure access to the tracking system. DNS (domain name system) can be the naming system used in the internet to find the physical IP address of the server hosting the domain name 402—the availability of a DNS server 406 web service is necessary in order to provide online access to the tracking system architecture 400. The host 434 can represent the physical (or virtual) servers that the tracking system's web applications or websites reside and run on. In FIG. 4, a cloud-based solution (or distributed computing—computing concepts that involve a large number of computers connected through a real-time communication network) for the host 434 is represented. This may be more favorable compared to dedicated hosting solutions in cases where easy scalability and redundancy are favorable. Certain embodiments of the disclosure may benefit from cloud-based hosting due to the high quantity of data that may need to be retained for periods potentially exceeding ten years and since tracking processes may be affected negatively by gaps in data collection caused by unforeseen outages of the hosting infrastructure. Subsystems used in cloud-based hosting architectures, the host 434, may include, but are not limited to, load balancer 408 that allow incoming user requests to be distributed across multiple servers allowing for additional hardware to be used to accommodate increased levels of user traffic; caching servers (i.e. memory 410) for storing data that needs to be accessed quickly; web servers 412 which run the system's applications and sites, holding the visual elements of the site as well as running any logic that needs to be done by the applications and sites; database server 414 that are responsible for storing information that the tracking system collects and uses—database server 414 may be set up in RAID arrays (redundant array of independent disks) with other database servers to prevent data from being lost if one of them happens to fail. The database storage 416 is responsible for keeping an organized collection of all data collected for the tracking of renewable electricity and associated renewable fuel credits in digital form. Secure asset storage 418 can be the location where files that are accessed infrequently are stored. Automated database backups 420 of the system's database can be performed regularly and stored utilizing the secure asset storage 418. Backend software 422 can be used to communicate instructions to the system's computers, it is responsible for any logic operations, algorithms, or behavior that needs to be completed or modified by the system. Source control 424 can be the process used to track and maintain the addition, deletion, and modification of large collections of files. Continuous integration server 426 allows for new code that is looking to be introduced into a production environment to be tested and then automatically integrated without the need to stop or power down the production environment. Outbound email 428 can be handled by a SMTP (simple mail transfer protocol) server that handles the physical process of sending email. The document redaction utility 430 allows for redaction and subsequent dynamically adjustable display of commercially sensitive documentation. System performance/uptime monitoring 432 is used to give insight into the performance of the web application or website—it provides information such as how frequently web servers are being used, which segments of software code are being called most often, the speed at which the system applications are responding, and what bottlenecks may exist in the system.

As desired, embodiments of the disclosure may include an architecture with more or less than the elements and/or operations illustrated in FIG. 4. Additionally, certain components of the architecture 400 may be combined in various embodiments of the disclosure. The architecture 400 of FIG. 4 is provided by way of example only.

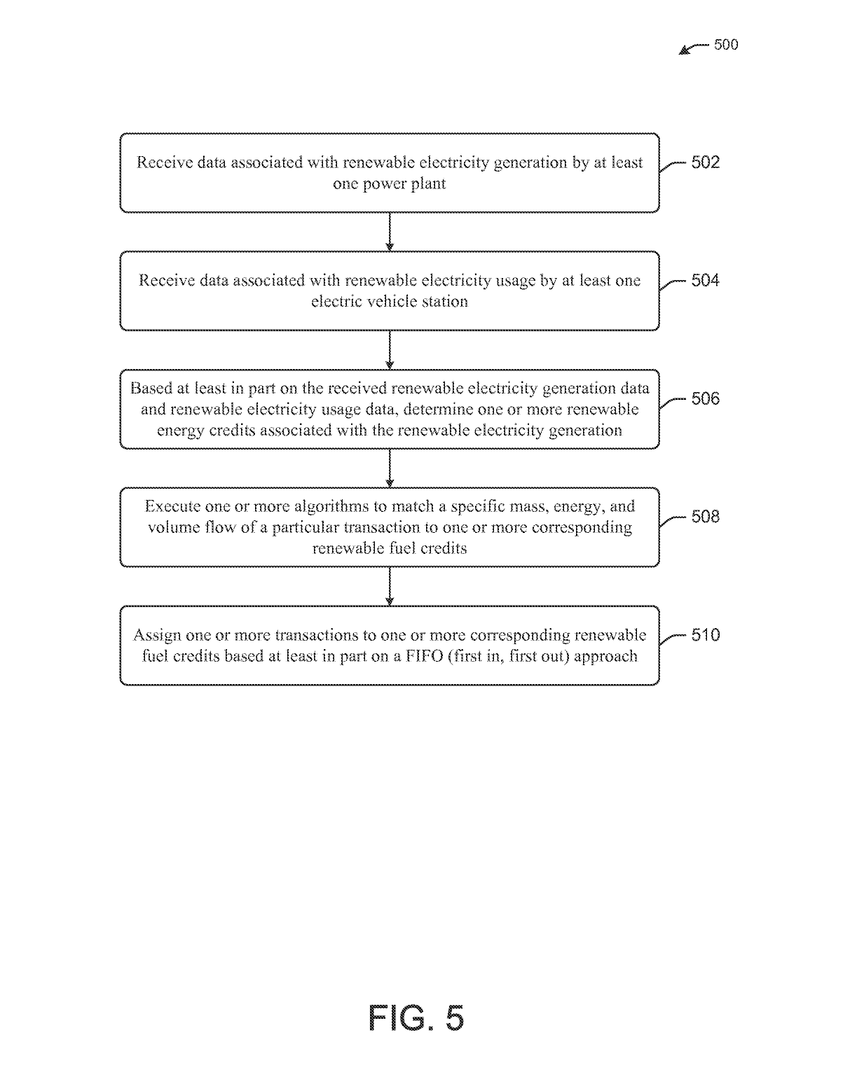

Turning now to FIG. 5, a flow diagram of an example method 500 for tracking renewable energy credits is illustrated according to one or more example embodiments. The method 500 can be implemented with some or all of the system components described with respect to process 100 in FIG. 1, data flow 200 in FIG. 2, system 300 in FIG. 3, and/or architecture 400 in FIG. 4. The method 500 may include block 502, in which a processor, such as a 304 in FIG. 3, may receive and/or otherwise access, from a service provider computer 318, data associated with renewable electricity generation by at least one power plant. In block 504, the processor 304 may receive and/or otherwise access, from the service provider computer 318, data associated with renewable electricity usage by at least one electric vehicle station. In block 506, the processor 304 may determine, based at least in part on the received renewable electricity generation data and renewable electricity usage data, one or more renewable energy credits associated with the renewable electricity generation. In block 508, the processor 304 may execute one or more algorithms to match a specific mass, energy, and volume flow of a particular transaction to one or more corresponding renewable fuel credits. In block 510, the processor 304 may assign one or more transactions to one or more corresponding renewable fuel credits based at least in part on a FIFO (first in, first out) approach. The method 500 can end after block 510.

In one aspect of an embodiment, the method 500 can include receiving feedstock procurement data from a feedstock source, a power plant, or a third party source.

In another aspect of an embodiment, the method can include receiving electricity generation data from one or more sources.

In another aspect of an embodiment, the method can include receiving usage data for produced renewable electricity and renewable fuel credit generation data.

In another aspect of an embodiment, the method can include receiving renewable fuel credit transaction data from one or more sources.

In another aspect of an embodiment, the method can include receiving, from one or more sources, aggregated mass, energy, and volume flow data corresponding to previously generated renewable fuel credits.

In another aspect of an embodiment, the method can include executing one or more algorithms to match a specific mass, energy, and volume flow of a particular transaction to one or more corresponding renewable fuel credits.

In another aspect of an embodiment, the method can include assigning transactions to one or more corresponding renewable fuel credits based at least in part on a FIFO (first in, first out) approach.

As desired, embodiments of the disclosure may include a process with more or less than the elements and/or operations illustrated in and/or described with respect to FIG. 5. Additionally, certain components of the process 500 may be combined in various embodiments of the disclosure. The process 500 of FIG. 5 is provided by way of example only.

Example Tracking Algorithms—Feedstock

In certain embodiments of the disclosure, various algorithms can be used to track particular aspects of a renewable electricity and associated renewable fuel credit generation process. For example, an algorithm can be used to track feedstock usage of one or more power plants, which can be a part of a renewable electricity and associated renewable fuel credit generation process according to certain embodiments of the disclosure. Data collection and processing of data related to feedstock procurement and usage in renewable electricity generation can be optional when tracking renewable electricity and associated renewable fuel credits generation. Feedstock tracking for any given renewable electricity and renewable fuel credits generation pathway can be mandated by a governmental or regulatory agency, and when implemented, certain operations associated with feedstock tracking can be executed to further facilitate the tracking of renewable electricity and associated renewable fuel credits.

The following is a non-exclusive list of scenarios related to feedstock procurement and usage of power plants, which may be pertinent for the tracking renewable electricity and associated renewable fuel credit generation:

A power plant uses biogas commingled with non-renewable natural gas as feedstock that is withdrawn from a common carrier pipeline; and

A power plant uses renewable and non-renewable feedstock (that may or may not be commingled), while data or documentation is not available which could prove that all electricity that renewable fuel credits are to be generated for is produced from renewable feedstock.

In some instances, tracking of feedstock procurement and usage may not be needed for the following scenarios, which can include, but are not limited to:

A power plant uses feedstock that is 100% renewable; and

A power plant uses renewable and non-renewable feedstock (that may or may not be commingled), while data or documentation is available proving that all electricity that renewable fuel credits are to be generated for is produced from renewable feedstock.

In any instance, depending on the determination made by a governmental or regulatory agency, feedstock tracking may differ from the non-exclusive scenarios listed above.

In certain embodiments, feedstock tracking can establish relatively organized feedstock records and specify the exact renewable content of a feedstock stream.

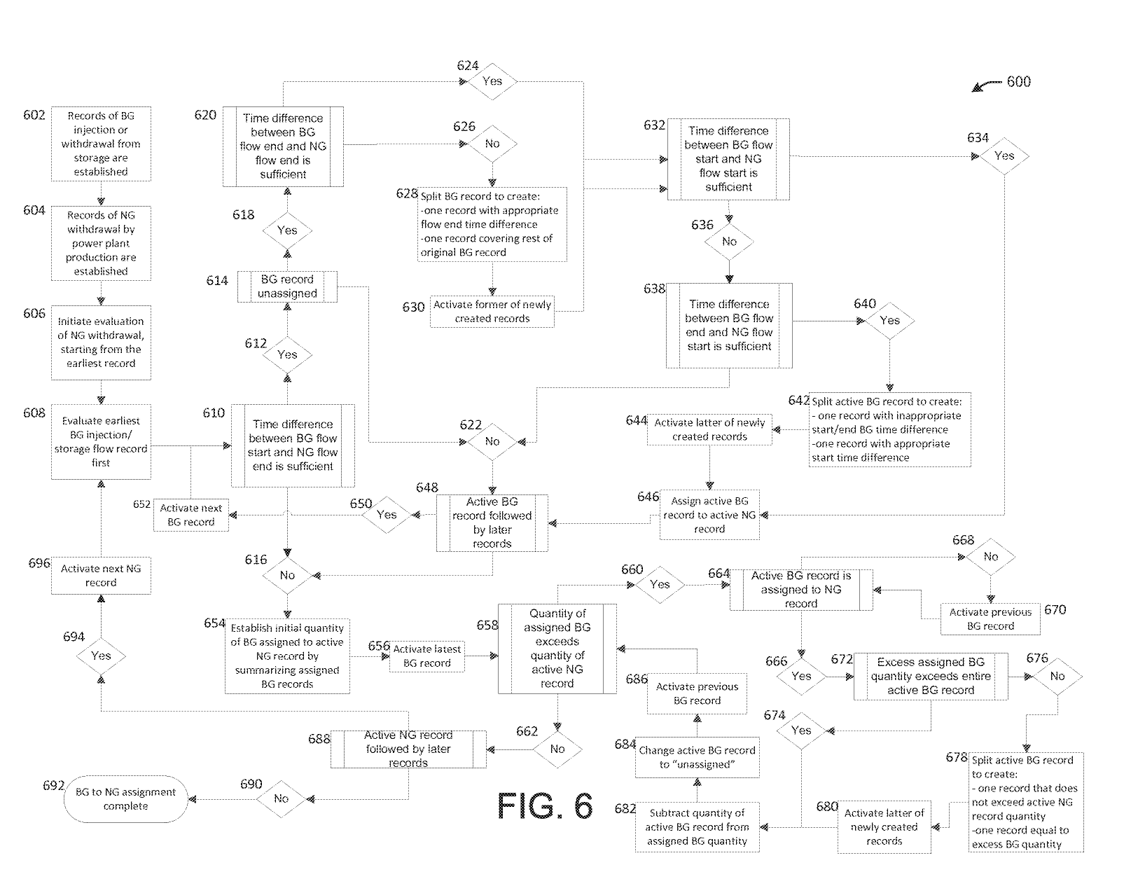

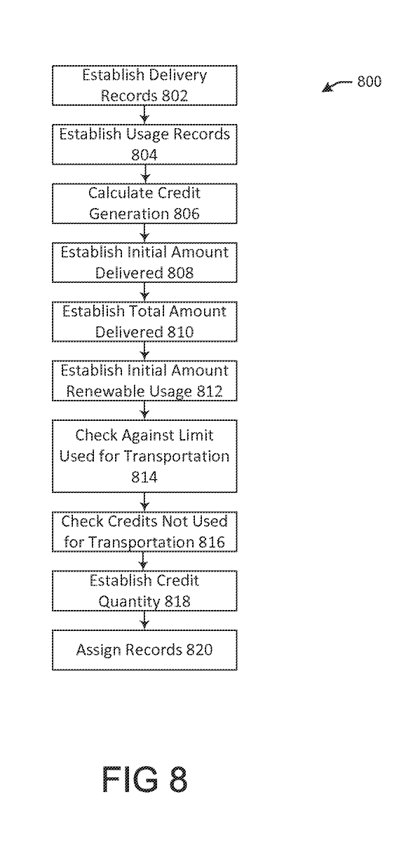

Turning to FIGS. 6, 7, and 8, example feedstock tracking algorithms for various systems and methods for tracking renewable energy credits are described according to one or more embodiments of the disclosure. In FIG. 6, the tracking algorithm 600 shown can be used when methane and/or biogas are commingled in a feedstock stream entering a power plant, wherein the commingled feedstock stream is referred to as natural gas or NG, and the amount of the renewable feedstock present in the total feedstock stream is unknown, according to an embodiment of the disclosure. In this case, the biogas dispensed by the feedstock source, either by injection into a connecting pipeline system after production or withdrawing it from a biogas inventory in storage, can be assigned to corresponding amounts of natural gas withdrawn by the power plant for purposes of renewable electricity generation to establish how much feedstock eligible for renewable fuel credit generation is used by the power plant. The term “injection” as used hereafter can refer to dispensing of biogas by a feedstock source as well as other scenarios in which a qualifying feedstock source introduces biogas into a pipeline system or storage facility for the purpose of supplying feedstock for renewable electricity generation. In this manner, by assigning biogas injection to natural gas withdrawal, an amount of renewable feedstock qualifying for generation of renewable fuel credits in the power plant's feedstock stream can be established.

In certain instances, assignment of biogas injection to natural gas withdrawal may be needed to satisfy certain requirements to allow for tracking of renewable electricity production and the generation of associated renewable fuel credits. For example, these requirements can include, but are not limited to, biogas assigned to natural gas used by the power plant is injected in a manner and at a time consistent with the withdrawal of natural gas by the power plant; biogas is to be injected no later than when the corresponding natural gas is withdrawn from the pipeline; a minimum time difference between the end of natural gas withdrawal and associated biogas injection may be required; if the biogas is injected prior to natural gas withdrawal by the power plant, there might be a maximum acceptable time difference between natural gas withdrawal and associated biogas injection (e.g. biogas may not be assigned to natural gas withdrawn more than a month after the biogas was injected); and the amount of biogas injected may not be more than the amount of natural gas that it is assigned to.

The tracking algorithm 600 of FIG. 6 can begin at block 602, in which the injection of biogas (BG) for supply of feedstock for renewable electricity generation can be stored as records in the tracking system (BG record). The information stored in each record on BG injection can include, but is not limited to, following:

t_{BG}_{ᵢ}⁻—Starting date (and time) of biogas injection in that record. Certain embodiments of the disclosure may need to be able to perform relatively simple operations with date and time data, such as subtracting two date and time variables to calculate the time difference between those date and time values.

t_{BG}_{ᵢ}⁺—End date (and time) of biogas injection in that record.

BG_{T}_{ᵢ}—The amount of biogas (e.g. in BTU) that was injected in the period between t_{BG}_{ᵢ}⁻ and t_{BG}_{ᵢ}⁺ (the period is indicated by Tᵢ written as a subscript to the variable).

ABG_{T}_{ᵢ}—Variable representing assignment of the BG record to a record of natural gas (NG) withdrawal by the power plant for renewable electricity generation. By default, the value of this variable can be 0, until it is assigned to a record of NG withdrawal.

AF_{RF}_{ᵢ}—Adjustment factor used to convert the amount of renewable biogas in record “i”—as recorded in the system—to feedstock energy.

BG records in the tracking system can be sorted by t_{BG}_{ᵢ}⁻ in an ascending order. The “i” index in the subscript may be a positive integer and can represent the sequential number of the BG record that each variable is assigned to. As such, for example t_{BG}⁻ can represent the date and time when recorded BG injection was initiated for the first time, while BG_{T}_{_{g}} could mean the amount of biogas injected when injection started for the fifth time.

Since the resolution of biogas injection data may vary greatly (e.g. Tᵢ may be anywhere from one second to one month, and gaps or outages in biogas injection or data supply may occur), the tracking system may be able to adapt to the source data. Accordingly, the algorithms described herein and below can demonstrate how BG records can be adjusted to accommodate the tracking procedure. While records may need to be split in order to achieve reliable assignment of biogas injection to natural gas withdrawal, some or all supporting documentation collected and recorded by the tracking system can remain linked to the records in order to support some or all data entered into the system.

Block 602 is followed by block 604, in which records of NG withdrawal (NG record) can be registered and sorted in a manner similar to that of BG injection. Information stored in each record on NG withdrawal can include, but is not limited to:

t_{NG}_{ⱼ}⁺—Starting date (and time) of natural gas withdrawal in that record.

t_{NG}_{ⱼ}⁺—End date (and time) of natural gas withdrawal in that record.

NG_{T}_{ⱼ}—The amount of natural gas (e.g. in BTU) that was withdrawn in the period between t_{NG}_{ⱼ}⁻ and t_{NG}_{ⱼ}⁺ (the period is indicated by Tⱼ written as a subscript to the variable).

ANG_{T}_{ⱼ}—Variable representing assignment of the NG record to a record of electricity generation (EG). By default, the value of this variable can be 0, until it is assigned to an EG record (see below for more details).

AF_{NRF}_{ⱼ}—Adjustment factor used to convert the amount of non-renewable natural gas in record “j”—as recorded in the system—to feedstock energy

NG records in the tracking system can be sorted by t_{NG}_{ⱼ}⁻ in an ascending order. The “j” index in the subscript may be a positive integer and can represent the sequential number of the NG record that each variable is assigned to.

Block 604 is followed by block 606, in which an assignment evaluation process from the first (earliest) NO withdrawal can be started. This can be represented by setting the current value of the “j” index (the index of the NO record that is to be evaluated) to 1, such as j→1

Block 606 is followed by block 608, in which for each NG record (represented by the value assigned to “j”), all BG records are evaluated, starting with the earliest one. This can be represented by setting the current value of the “i” index (the index of the BG record that is to be evaluated) to 1., such as j→1.

Block 608 is followed by routine block 610, in which a determination whether injection of biogas in active record “i” was not started after the natural gas was withdrawn in order to establish whether assignment to active record “j” is feasible, for example, using the equation:

t_{NG}_{ⱼ}⁺−t_{BG}_{ᵢ}⁻≧τ⁰

In the above equation:

τ⁰—the minimum time needed to pass between start of BG injection and the end of NG withdrawal that it is assigned to (e.g. may be set to zero if the only requirement is that BG shouldn't be injected after NG is withdrawn); and

If the active “i” BG record satisfies the condition, it is further analyzed by following the YES branch 612 to block 614. If not, the NO branch 616 is followed to block 654, where analysis of BG records for assignment to the active “j” NO record can be interrupted, since following BG records may not satisfy this condition either (due to the fact that BG records are sorted by t_{BG}_{ᵢ}⁻ in an ascending order).

At subroutine block 614, a determination is made whether the active “i” BG injection record is already assigned to a NG withdrawal record. For example, this can be achieved by evaluating following statement: ABG_{T}_{_{L}}=0

If the statement is true, the YES branch 618 is followed to block 620, where the BG record is analyzed in subsequent steps. If the BG record is already assigned to a NG record, the NO branch 622 is followed to block 648, where no additional operations are performed using the record.

At subroutine block 620, a determination is made whether biogas injection in the active “i” record ends later than natural gas withdrawal ends in the active “j” record, for example, using the following equation:

t_{NG}_{ⱼ}⁺−t_{BG}_{ᵢ}⁺≧τ⁺

In the above equation:

τ⁺—the minimum time that needed to pass between the end of BG injection and the end of NG withdrawal that it is assigned to (e.g. may be set to zero if the only requirement is that BG shouldn't be injected after NG is withdrawn).

If the “i” BG record satisfies the above condition, the YES branch 624 is followed to block 630. However if the statement is false, the NO branch 626 is followed to block 628.

At block 628, the BG record can be split to avoid ambiguity in BG to NG record assignment. Thus, if BG injection in the active “i” record ends after NG withdrawal in the active “j” record, the “i” record can be split to create a BG injection record that ends at, for instance, t_{NG}_{ⱼ}⁺−τ⁺, and that may be assigned to the active “j” NG record. In this example, the following algorithm can be used to describe the addition of a new record, to which values can be assigned in a subsequent step:

if j=m

then m→m+1

If the active BG record is the last that is currently stored, the maximum number of records can be extended by 1:

else m→m+1

for each n=1 to (m−i−1):

i+n→i+n+1

n→n+1

If the active BG record is followed by additional records, the maximum number of records can be extended by 1 and the “i” indices of all subsequent records can be increased by 1, making the currently active “i” record the one that may be assigned to the “j” NG record and “i+1” can be the record covering the remainder of the original BG record.

In the above equation:

m—the number of BG records present in the tracking system.

n—variable representing positive integers used to describe looping through all BG records.

Values are assigned to the newly created “i+1” BG record and the adjusted “i” BG record can be as follows:

$${t}_{{BG}_{i + 1}}^{+} \to {t}_{{BG}_{i}}^{+}$$

$${t}_{{BG}_{i}}^{+} ; {t}_{{BG}_{i + 1}}^{-} \to {t}_{{NG}_{j}}^{+} - \text{?}$$

$${BG}_{{T}_{i + 1}} \to \text{?} * \frac{{t}_{{BG}_{i + 1}}^{+} - {t}_{{BG}_{i + 1}}^{-}}{{t}_{{BG}_{i + 1}}^{+} - {t}_{{BG}_{i}}^{-}}$$

$${BG}_{{T}_{i}} \to {BG}_{{T}_{i}} - {BG}_{{T}_{i + 1}}$$

$$\text{?} \to \text{?}$$

$$\text{?} \text{indicates text missing or illegible when filed}$$

The starting and end times of the resulting BG records can be set and the amount of BG injected in the original record can be distributed proportionally between the newly created records. Going forward, the BG record “i” can remain the record that may be assigned to “j” NG record following additional adjustments.

In the case that biogas injection from more than one source is monitored using certain embodiments of the disclosure, BG records with indices “i+1” to “m” may be resorted after the above algorithm is executed to ensure suitable operation of the tracking system (e.g. it is possible that as a result of the creation of record “i+1”: t_{BG}_{ᵢ₊₁}⁺>t_{BG}_{ᵢ₊₂}⁺).

Further, the above algorithm—not unlike other adjustment described hereunder—assumes that injection flow rate of the “i” BG record can be constant. While this may not strictly reflect actual biogas injection processes (by ignoring fluctuations of flow rate), it can result in relatively unambiguous and accurate tracking of renewable feedstock usage. Furthermore, in the case of “high-resolution” biogas injection data (e.g. continuous recording of biogas injection per minute)—which is favorable and to be expected in the majority of real life applications—the difference between the actual physical flow and the calculated record splitting can be marginal; since the total amount of injected biogas may be unchanged, and overestimation of renewable feedstock may not be possible.

At block 630, as previously described above, the active “i” BG record can remain the record that may be assigned to “j” NG record following additional adjustments. As such, this operation can clarify the flow and may not strictly reflect a specific operation that is to be performed by embodiments of the disclosure.

At subroutine block 632, a determination is made whether the time gap between start of BG flow in record “i” and NG withdrawal in record “j” is unacceptably large as follows:

t_{NG}_{ⱼ}⁻−t_{BG}_{ᵢ}⁻≦τ⁻

In the above equation:

τ⁻—the maximum time that is allowed to pass between start of BG injection and the start of NG withdrawal that it is assigned to (e.g. setting the value to 7 days can mean that biogas may only be assigned to NG withdrawal that occurred within a week of injection).

If the above statement is true, the YES branch 634 is followed to block 646, where an active “i” BG record may be assigned to the active “j” NG record. In case the record does not satisfy this criteria, the NO branch 636 is followed to block 638, where subsequent analysis may be performed.

At subroutine block 638, after it is established in block 632 that the active “i” BG record does not start within the acceptable time period of NG withdrawal, a determination is made whether the BG record ends within that timeframe, for example, using the following equation:

t_{NG}_{ⱼ}⁻−t_{BG}_{ᵢ}⁺≦τ⁻

If this criteria is not satisfied, the NO branch 622 followed to block 648, where an active “i” BG record may not be assigned to the active “j” NG record. If the above equation is true, the YES branch 640 is followed to block 642.

At block 642, which is similar to block 628, the active BG record “i” may be split to create one record that satisfies the criteria of subsequent block 632 and one covering part of the currently active BG record “i” that may not be assigned to active NG record “j”.

Accordingly, a new record can be created as follows:

if i=m

then m→m+1

else m→m+1

for each n=1 to (m−i−1):

i+n→i+n+1

n→n+1

Values are assigned to the newly created “i+1” BG record and the adjusted “i” BG record as follows:

$${t}_{{BG}_{i + 1}}^{+} \to {t}_{{BG}_{i}}^{+}$$

$${t}_{{BG}_{i}}^{+} ; {t}_{{BG}_{i + 1}}^{-} \to {t}_{{NG}_{j}}^{+} - \text{?}$$

$${BG}_{{T}_{i + 1}} \to \text{?} * \frac{{t}_{{BG}_{i + 1}}^{+} - {t}_{{BG}_{i + 1}}^{-}}{{t}_{{BG}_{i + 1}}^{+} - {t}_{{BG}_{i}}^{-}}$$

$${BG}_{{T}_{i}} \to {BG}_{{T}_{i}} - {BG}_{{T}_{i + 1}}$$

$$\text{?} \to \text{?}$$

$$\text{?} \text{indicates text missing or illegible when filed}$$

After the above adjustments have been executed, the currently active “i” BG record may not satisfy either of the requirements of subsequent blocks 632 and 638, and thus, may not be assigned to the active NG record “j”

Block 642 is followed by block 644, in which the currently active BG record “i” may not be assigned to the currently active “j” NG record, while the newly created “i+” BG record may satisfy all injection time start/end requirements. Thus, BG record “i+1” is activated as follows:

i→i+1

Block 644 is followed by block 646, in which after all adjustments needed to satisfy the requirement of the time of biogas injection assigned to NG withdrawal, the currently active BG record “i” can be assigned to NG record “j” as follows:

ABG_{η}→j

Block 646 is followed by subroutine block 648, in which a determination is made whether the currently active “i” BG record is the last one, which determines the next operation to be executed, as follows:

i<m

If the above equation is true, the YES branch 650 is followed to block 652, in which the algorithm skips to the next BG record and the algorithm returns to subroutine block 610 described above. If the equation is not true, the NO branch 616 is followed to block 654, in which an evaluation of the amount of biogas assigned to currently active NG record “j” can be initiated.

Turning back to block 652, the equation to skip to next BG record is as follows:

i→i+1

Turning back to block 654, after initial assignment of BG records to the currently active “j” NO record, a summary of the amount of biogas in the BG records assigned to “j” NO record can be established as follows:

for each i=1 to (m−1)

if ABG_{T}_{ᵢ}=j

FE_{R,T}_{ⱼ}→FE_{R,T}_{ⱼ}+BG_{T}_{ᵢ}*AF_{RF}_{ᵢ}

i→i+1

In the above equation:

FE_{R,T}_{ⱼ}—Total feedstock energy of renewable biogas assigned to “j” NG record (value 0 if no biogas records are assigned to “j” NG record).

Block 654 is followed by block 656, in which when evaluating the amount of biogas assigned to “j” record of NG, the last BG record may be analyzed first as follows:

k→0

In the above equation:

k—can be a non-negative integer used in the description of the tracking algorithms to cycle through the BG records from last to first.

Block 656 is followed by subroutine block 658, in which a determination is made whether the feedstock energy of biogas assigned to the currently active “j” NG record is not greater than the initial feedstock energy of the amount of non-renewable natural gas in the “j” record as follows:

FE_{R,T}_{ⱼ}≦NG_{T}_{ⱼ}*AF_{NRF}_{ⱼ}

If the above condition is satisfied, the YES branch 660 is followed to block 664, in which biogas assignment to NG record “j” is finalized. If the above condition is not satisfied, the NO branch 662 is followed to block 688, in which additional adjustment can be made since the feedstock energy of the assigned biogas is greater than that of the non-renewable natural gas withdrawn by the power plant.

Turning back to subroutine block 664, a determination is made whether the active BG record “m−k” is assigned to active NG record “j” as follows:

ABG_{T}_{ₘ₋ₖ}=j

If the above equation is true, the YES branch 666 is followed to block 672, in which part or all of the BG record can be unassigned from the “j” NG record. In case the equation is false, the NO branch 668 is followed to block 670, in which the previous BG record can be activated for evaluation as follows:

k→k+1

Turning back to subroutine block 672, a determination is made whether the entire amount of biogas injected in the currently active “m−k” BG record can be unassigned from “j” NG record as follows:

FE_{R,T}_{ⱼ}−NG_{T}_{ⱼ}*AF_{NRF}_{ⱼ}≧BG_{T}_{ₘ₋ₖ}*AF_{RF}_{ₘ₋ₖ}

If the above criteria are satisfied, the YES branch 674 is followed to block 682, in which the entire active “m−k” BG record may be unassigned from the “j” NG record. If the above criteria are not satisfied, the NO branch 676 is followed to block 678, in which the “m−k” BG record can be split to deduct a suitable amount of biogas from the “j” NG record.

At block 678, the currently active “m−k” BG record can be split to create a BG record that may be unassigned from the “j” NG record. For example, the following algorithm can be used to add a new record, to which values can be assigned as follows:

if k=0

then m→m+1

If the active BG record is the last that is currently stored, the maximum number of records can be extended by one as follows:

else m→m+1

for each p=0 to (k−1):

m−k+p→m−k+p+1

p→p+1

Since “m” was increased by 1 in the initial step, “m−k” can reference the newly created BG record, that will be unassigned from “j” NG record, while the original BG record can be referred to using “m−k−1”.

In the above equation:

p—variable representing nonnegative integers used to describe looping through BG records.

Values can be assigned to the BG records as follows:

$$\text{?} \to \text{?}$$

$$\text{?} \to \text{?}$$

$${BG}_{{T}_{m - k - 1}} \to {BG}_{{T}_{m - k - 1}} - {BG}_{{T}_{m - k}}$$

$${t}_{{BG}_{m - k}}^{+} \to {t}_{{BG}_{m - k - 1}}$$

$${t}_{{BG}_{m - k}}^{-} ; {t}_{{BG}_{m - k - 1}}^{+} \to {t}_{{BG}_{m - k}}^{+} - ( {t}_{{BG}_{m - k}}^{+} - {t}_{{BG}_{m - k - 1}}^{-} ) * \frac{{BG}_{{T}_{m - k}}}{{BG}_{{T}_{m - k}} + {BG}_{{T}_{m - k - 1}}}$$

$$\text{?} \text{indicates text missing or illegible when filed}$$

The newly created “m−k−l” BG record can have a feedstock energy equal to the excess BG feedstock energy assigned to “j” NG record, while the adjusted original “m−k−l” contains the rest of the biogas. The starting end times of the newly created and adjusted BG records can be proportionate to the distribution of feedstock energy.

Block 678 is followed by block 680, in which the active “m−k” BG record is the record that is unassigned from the “j” NG record. As such, this operation is intended as clarification of the flow chart and does not strictly reflect an operation that is to be performed.

Block 680 is followed by block 682, in which a decrease or elimination of the excess BG quantity assigned to “j” NG record is performed, where the feedstock energy of biogas injection in the currently active “k−m” BG record can be subtracted from the feedstock energy of renewable biogas assigned to “j” NG record as follows:

FE_{R,T}_{ⱼ}→FE_{R,T}_{ⱼ}−BG_{T}_{ₖ₋ₘ}*AF_{RF}_{ₖ₋ₘ}

Block 682 is followed by block 684, in which the currently active “m−k” BG record can be unassigned from the “j” NG record as follows:

ABG_{T}_{ₘ₋ₖ}→0

Block 684 is followed by block 686, in which the previous BG record can be skipped to as follows:

k→k+1

Block 686 is followed by subroutine 658, described above, which routes to the NO branch 662, and then to subroutine block 688, in which a determination is made whether the currently active “j” NG record is the last one registered as follows:

j=r

In the above equation:

r—the number of NG records present in the tracking system.

If the result is true, the NO branch 690 is followed to block 692, in which the assignment of BG records to NG records can be concluded. In the case of a negative outcome, the YES branch 694 is followed to block 696, in which assignment procedure can be continued with the next NG record.

At block 696, the next NG record can be skipped to as follows:

j→j+1

After block 696, the algorithm can continue to block 608 as described above.

Turning back to block 692, after the final feedstock energy from renewable feedstock of “j” NG record is established in block 682, the feedstock energy from non-renewable feedstock may be calculated as follows:

FE_{NR,T}_{ⱼ}→NG_{T}_{ⱼ}*AF_{NRF}_{ⱼ}−FE_{R,T}_{ⱼ}

In the above equation:

FE_{NR,T}_{ⱼ}—Total feedstock energy of non-renewable natural gas assigned to “j” NG record.

After block 692, the algorithm 600 can end.

In certain embodiments of the disclosure, biogas may be metered separately from non-renewable natural gas. For instance, one or more power plants may procure renewable natural gas for renewable electricity generation in a way that allows for direct metering of the renewable and non-renewable feedstock streams. The exact quantity of renewable natural gas used for renewable electricity may be established directly in certain cases that include, but are not limited to, the following: biogas is produced on site and there is no need for long-distance transport of the feedstock; and biogas is transported using a dedicated pipeline or other dedicated transportation infrastructure (e.g. gas tanks).

Certain embodiments of the disclosure may be able to record the renewable and non-renewable natural gas streams that are used for renewable electricity generation, and thus, establish exact records of renewable and non-renewable feedstock usage. The structure of the resulting NG_{T}_{ⱼ} records may be similar (or identical) to that established in the above algorithm 600 described in FIG. 6, and recording of biogas injection (establishing BG_{T}_{ᵢ} records) may not be necessary.

Since renewable and non-renewable feedstock streams are not commingled, FE_{R,T}_{ⱼ} or FE_{NR,T}_{ⱼ} of each natural gas withdrawal (or usage) record may be established directly when feedstock usage data is registered by the system, and biogas-to-natural gas assignment operations as described above in the case of transportation via common carrier pipeline may not be necessary.

In certain embodiments, procurement of non-biogas feedstock used for renewable electricity generation may need to be tracked (e.g. in the case of biomass). As opposed to biogas, non-biogas feedstock may be transported directly to the power plant, not using a common carrier pipeline or other infrastructure where renewable and non-renewable feedstock is commingled. Loads of non-biogas feedstock delivered to the power plant may be recorded in a similar manner as outlined above. Differences between records established for biogas and non-biogas feedstock may include, but are not limited to, the following: establishing biogas injection—BG_{T}_{ᵢ}—records may not be necessary; for all loads t_{NG}_{ⱼ}⁻=t_{NG}_{ⱼ}⁺; FE_{R,T}_{ⱼ} and FE_{NR,T}_{ⱼ} may be established for each loads when feedstock procurement data is registered in the system.

As can be seen below, non-biogas feedstock records may be compatible with the subsequent and/or consecutive processes that enable tracking of renewable electricity and associated environmental credits generation.

Example Tracking Algorithms—Renewable Electricity Production

In another example, an algorithm can be used to track renewable electricity production or generation of one or more power plants, which can be a part of a renewable electricity and associated renewable fuel credit generation process according to certain embodiments of the disclosure. Depending on the availability and necessity of feedstock procurement and usage, as well as power plant electricity generation data, data collection and management processes discussed herein can be optional when tracking renewable electricity and associated renewable fuel credits generation. Certain embodiments of the disclosure may be able to establish a record of renewable electricity generation, thus permitting certain assurances to be provided that predefined requirements can be met by a particular power plant. A non-exclusive list of checks and data management services performed by certain embodiments of the disclosure can include, but are not limited to the following: the amount of renewable electricity generated is in accordance with the power plant's registered capacity; and feedstock procurement can be assigned to electricity generation, establishing that renewable feedstock was procured and used in a manner that is consistent with the generation of renewable electricity. Electricity generation records may be established in a manner that is consistent with fedstock records. Algorithms that may be used to assign feedstock procurement and usage to generation of electricity are discussed further below. Although the abbreviation “NG record” is used for natural gas withdrawn for the purposes of electricity generation in the above; all types of feedstock (biogas and non-biogas) may be referred to using this abbreviation in addition to any corresponding variables in order to be consistent and facilitate understanding of the algorithms. Thus, one skilled in the art should be able to recognize the applicability of the embodiments disclosed herein can be used to track any type of feedstock involved in renewable electricity and associated environmental credits generation.

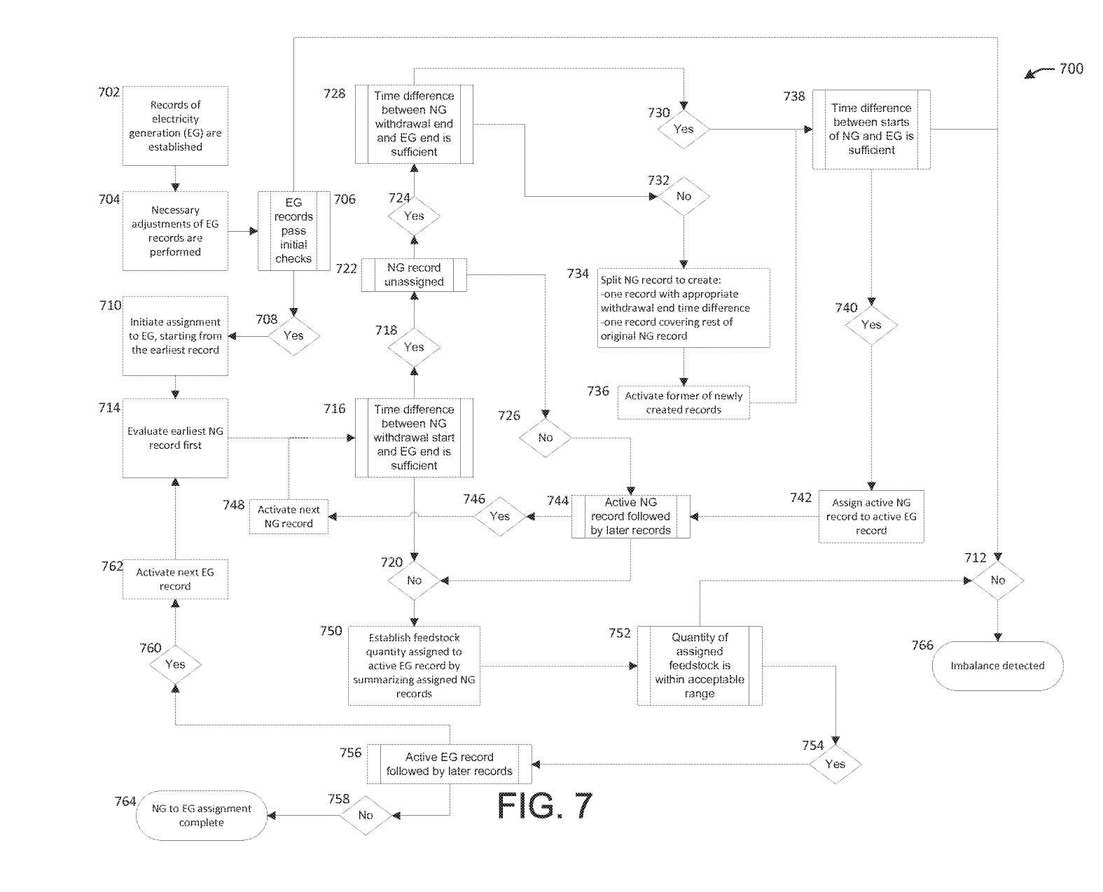

In FIG. 7, the tracking algorithm 700 shown can be used for tracking renewable electricity generation according to an embodiment of the disclosure. The tracking algorithm 700 of FIG. 7 can begin at block 702, in which data can be registered in electricity generation (EG) records, which may include, but is not limited to, the following:

t_{EG}_{_{q}}⁻—Starting date (and time) of electricity generation in that record.

t_{EG}_{_{q}}⁺—End date (and time) of electricity generation in that record.

EG_{T}_{_{q}}—The amount of electricity (e.g. in kWh) that was generated by the power plant in the period between t_{EG}_{_{q}}⁻ and t_{EG}_{_{q}}⁺.

AF_{EG}_{_{q}}—Adjustment factor used to adjust electricity generation data. This factor may vary greatly based at least in part on the specifics of the monitored power plant and renewable electricity generation process. The availability, point and method of electricity generation metering may also greatly influence the value and application of this factor. Thus, AF_{EG}_{_{q}} may be a function of EG_{T}_{_{q}} and/or several additional factors.

In any instance. EG records can be sorted by t_{EG}_{_{q}}⁻ in an ascending order. The “q” index in the subscript may be a positive integer and can represent the sequential number of the EG record that each variable is assigned to.

Block 702 is followed by block 704, in which adjustments to the EG records can be performed, for instance, the EG_{T}_{_{q}} amount of electricity production in each record may be adjusted as follows:

EG_{T}_{_{q}}→EG_{T}_{_{q}}+AP_{EG}_{_{q}}

The adjustment may vary based on the tracked process and facility. Factors that may necessitate and/or determine specific adjustments can include, but are not limited to, parasitic losses, characteristics of combined cycle power plants, and exact point and source of electricity data monitoring.

Block 704 is followed by subroutine 706, in which EG record checks can be performed. When electricity generation records are established in the system, one or more checks can be performed to ensure that one or more parameters of electricity generation are within suitable and/or acceptable limits. These checks may include, but are not limited to, the following:

EG_{T}_{_{q}}≦EGₘₐₓ*T_{q}

This check can detect whether newly establishes electricity generation records might exceed the power plant's production capacity in the T_{q} period.

In the above equation:

EGₘₐₓ—the maximum electricity production capacity of the power plant (e.g. in kWh/day).

EGₘₐₓ may be, for example, determined by using the power plant's permitted capacity or third party engineering review data.

Checks performed on electricity generation data may vary greatly based on the characteristics of the power plant and tracked pathway. The above serves as an example of one or more checks and evaluations that may be performed by embodiments of the disclosure and should not be construed as a limitation.

If the EG records pass the initial checks, the YES branch 708 can be followed to block 710. If the EG records do not pass the initial checks, the NO branch 712 can be followed to block 766, where an imbalance is detected.

Turning to block 710, an assignment evaluation is initiated beginning with the first (earliest) electricity generation record. For instance, this can be represented by setting the current value of the “q” index (the index of the EG record that is to be evaluated) to 1 as follows:

q→1

Block 710 is followed by block 714, in which the assignment evaluation process proceeds from the first (earliest) feedstock usage record. For instance, this can be represented by setting the current value of the “j” index (the index of the NG record that is to be evaluated) to 1 as follows:

j→1

Block 714 is followed by subroutine 716, in which a determination is made whether usage of feedstock in active record “j” has not commenced after electricity generation in active “q” record has stopped in order to establish whether assignment to active record “j” is feasible as follows:

t_{EG}_{_{q}}⁺−t_{NG}_{ⱼ}⁻≧τ_{EG}⁰

In the above equation:

τ_{EG}⁰—the minimum time difference between start of feedstock usage and the end of electricity generation that it is assigned to (e.g. may be set to zero if the only requirement is that feedstock usage should occur no later than electricity generation).

If the active “j” NG record satisfies the condition, the YES branch 718 can be followed to block 722, where it can be further analyzed. If the condition is not satisfied, the NO branch 720 is followed to block 750, where analysis of NG records for assignment to the active “q” EG record can be interrupted, since subsequent NG records may not satisfy the condition either (since NG records are sorted by t_{NG}_{ⱼ}⁻ in an ascending order).

Turning to subroutine block 722, in which a determination is made whether the active “j” feedstock usage record is already assigned to an EG record. For instance, this can be achieved by evaluating the following:

ANG_{T}_{ⱼ}=0

If the statement is true, the YES branch 724 is followed to block 728, where the NG record can be analyzed in subsequent operations. If the NG record is already assigned to an electricity generation record, the NO branch 726 can be followed to block 744, no additional operations are performed using the record.

Turning to subroutine block 728, a determination is made whether feedstock usage in the active “j” record ends later than electricity generation ends in the active “q” record as follows:

t_{EG}_{_{q}}⁺−t_{EG}_{ⱼ}⁺≧τ_{EG}⁺

In the above equation:

τ_{EG}⁺—the minimum time to pass between the end of feedstock usage and the end of electricity generation that it is assigned to (e.g. may be set to zero if the only requirement is that feedstock should not be used after electricity generation has stopped).

If the “j” NO record satisfies the above condition, the YES branch 730 is followed to block 738, where further analysis can be made. However if the statement is false, the NO branch 732 is followed to block 734, the NO record can be split to avoid ambiguity in NG to EG record assignment.

Turning to block 734, if feedstock usage in the active “j” NG record ends after electricity generation in the active “q” record, the “j” record can be split to create a NG injection record that ends at t_{EG}_{_{q}}⁺−τ_{EG}⁺ that may be assigned to the active “q” EG record. In this instance, the following algorithm can be used to describe addition of a new record, to which values can be assigned as follows:

if j=r

then r→r+1

else r→r+1

for each n=1 to (r−j−1):

i+n→i+n+1

n→n+1

In the above equation:

n—variable representing positive integers used to describe looping through all NG records.

Values can be assigned to the newly created “j+1” NG record and the adjusted “j” NG record as follows:

$${t}_{{NG}_{j + 1}}^{+} \to {t}_{{NG}_{j}}^{+}$$

$${t}_{{NG}_{j}}^{+} ; {t}_{{NG}_{j + 2}}^{-} \to \text{?} - {τ}_{EG}^{+}$$

$${NG}_{{T}_{j + 2}} \to {NG}_{{T}_{j}} + \frac{{t}_{{NG}_{j + 1}}^{+} - {t}_{{NG}_{j + 2}}^{-}}{{t}_{{NG}_{j + 1}}^{+} - {t}_{{NG}_{j}}^{-}}$$

$${NG}_{{T}_{j}} \to {NG}_{Tj} - {NG}_{{T}_{j + 2}}$$

$$\text{?} \text{indicates text missing or illegible when filed}$$

In the case that feedstock usage is from more than one monitored sources, NG records with indices “j+1” to “r” may be resorted after the above algorithm is executed.

Block 734 is followed by block 736, in which the active “j” NG record remains to be the record that may be assigned to “q” EG record following additional adjustments. As such, this operation is intended as clarification of the flow chart and does not strictly reflect an operation that is to be performed.

Block 736 is followed by subroutine block 738, in which a determination is made whether the time gap between start of feedstock usage in record “j” and electricity generation in record “q” is not too large as follows:

t_{EG}_{_{q}}⁻−t_{NG}_{ⱼ}⁻≦τ_{EG}⁻

In the above equation:

τ_{EG}⁻—the maximum time that is allowed to pass between start of feedstock usage and the start of electricity generation that it is assigned to.

If the above statement is true, the YES branch 740 is followed to block 742, where the active “j” NG record may be assigned to the active “q” EG record. In case the record does not satisfy the above criteria, the NO branch 712 is followed to block 752, where the NG to EG assignment can be interrupted and deeper analysis of the NG and EG data sets may be necessary. Splitting the NG record in this case can lead to the former of the resulting NG records to be unassigned to electricity generation at the end of the allocation algorithm. Thus, interruption of the default assignment algorithm can be made since the feedstock usage may need to be assigned to electricity generation to assure suitable tracking of renewable electricity generation.

Turning to block 742, after all adjustments to satisfy the time of feedstock usage assigned to electricity generation, the currently active NG record “j” can be assigned to EG record “q” as follows:

ANG_{T}_{ⱼ}→q

Block 742 is followed by subroutine block 744, in which a determination is made of the next operation to be executed. For example, a determination is made whether the currently active “j” BG record is the last one or not as follows:

j<r

If the above equation is true, the YES branch 746 is followed to block 748, in which the next NG record is skipped to. If the equation is not true, the NO branch 720 is followed to block 750, in which evaluation of the amount of feedstock assigned to currently active EG record “q” can be initiated.

Turning back to block 748, the next NG record is skipped to as follows:

j→j+1

Turning back to block 750, after initial assignment of feedstock usage records to the currently active “q” EG record, the amount of feedstock energy of the NG records assigned to “q” EG record can be summarized as follows:

for each j=1 to (r−1)

if ANG_{T}_{ⱼ}=q

FE_{R,T}_{_{q}}→FE_{R,T}_{_{q}}+FE_{R,T}_{ⱼ}

FE_{NR,T}_{_{q}}→FE_{NR,T}_{_{q}}+FE_{NR,T}_{ⱼ}

j→j+1

In the above equation:

FE_{R,T}_{_{q}}—Total feedstock energy of renewable feedstock assigned to “q” EG record (value 0 if no feedstock usage records are assigned to “q” EG record).

FE_{NR,T}_{_{q}}—Total feedstock energy of non-renewable feedstock assigned to “q” EG record (value 0 if no feedstock usage records are assigned to “q” EG record).

Block 750 is followed by subroutine block 752, in which a determination is made whether the total feedstock energy assigned to the currently active “q” EG record satisfies predefined requirements regarding feedstock usage and electricity generation as follows:

$${δ}_{FE}^{-} \frac{{FE}_{R , {T}_{Q}} + {FE}_{NR , {T}_{Q}} + \text{?}}{{EG}_{{T}_{q}}} - {EG}_{st}^{FE} {δ}_{FE}^{+}$$

$$\text{?} \text{indicates text missing or illegible when filed}$$

In the above equation:

AF_{EG}_{_{q}}^{F}—Adjustment factor that may be applied to the feedstock energy assigned to “q” electricity generation record in order to suitably evaluate feedstock used in the generation of EG_{T}_{_{q}}, AF_{EG}_{_{q}}^{F} may or may not be a function of FE_{R,T}_{_{q}}, FE_{NR,T}_{_{q}}, EG_{T}_{_{q}} and other factors. Furthermore, the applicability and exact requirements of AF_{EG}_{_{q}}^{F} may vary greatly based at least in part on the tracked pathway and operations of the monitored power plant.

EGₛₜ^{FE}—Feedstock usage efficiency factor used to evaluate the amount of feedstock usage assigned to “q” electricity generation record. This factor may be established based at least in part on registration or engineering review data of the facility and may be the function of FE_{R,t}_{_{q}}, FE_{NR,T}_{_{q}}, EG_{T}_{_{q}} and/or other factors.

δ_{FE}⁺—Higher limit of the tolerance interval, within which the outcome of feedstock usage versus electricity generation evaluation is accepted. δ_{FE}⁺ may be the function of FE_{R,T}_{_{q}}, FE_{NR,T}_{_{q}}, EG_{T}_{_{q}} and/or other factors.

δ_{FE}⁻—Lower limit of the tolerance interval, within which the outcome of feedstock usage versus electricity generation evaluation is accepted. δ_{FE}⁻ may be the function of FE_{R,T}_{_{q}}, FE_{NR,T}_{_{q}}, EG_{T}_{_{q}} and/or other factors.

If the above condition is satisfied, the YES branch 754 is followed to block 756, where the feedstock usage assignment to EG record “q” is finalized. In case the outcome of the above check is unsatisfactory, the NO branch 712 is followed to block 766, where feedstock usage to electricity production assignment is interrupted and further analysis of the data set may be necessary.

Turning back to subroutine block 756, a determination is made whether the currently active “q” EG record is the last one registered as follows:

q=s

In the above equation:

s—the number of NG records present in the tracking system.

If the result is true, the NO branch 758 is followed to block 764, where assignment of NG records to EG records is concluded. In the case of a negative outcome, the YES branch 760 is followed to block 762, where an assignment procedure is continued with the next EG record.

In block 762, the next EG record is skipped to as follows:

q→q+1

Block 762 is followed by block 714, where the algorithm 700 continues.

Turning back to block 764, the NG to EG assignment is completed, and the algorithm 700 can end.

Example Tracking Algorithms—Electricity Disposition and Renewable Fuel Credit Generation

In another example, an algorithm can be used to track electricity disposition to one or more EV stations, which can be a part of a renewable electricity and associated renewable fuel credit generation process according to certain embodiments of the disclosure.

The algorithm 800 can begin at block 802, in which one or more records can be established for the amount of electricity that is delivered by one or more parties supplying renewable electricity to one or more EV stations, which may contain information including, but not limited to:

t_{ED}_{ᵤ}⁻—Starting date (and time) of electricity delivery in that record.

t_{ED}_{ᵤ}⁺—End date (and time) of electricity delivery in that record.

ED_{T}_{ᵤ}—The amount of electricity (e.g. in kWh) that was delivered in the period between t_{ED}_{ᵤ}⁻ and t_{ED}_{ᵤ}⁺.

RED_{T}_{ᵤ}—The amount of renewable electricity (e.g. in kWh) that was delivered in the Tᵤ period between t_{ED}_{ᵤ}⁻ and t_{ED}_{ᵤ}⁺.

AF_{ED}_{ᵤ}—Adjustment factor used to adjust electricity delivery data (e.g. for parasitic, transportation and delivery losses). This factor may vary greatly based on the specifics of the electricity delivery process. The availability, point and method of electricity delivery metering may also greatly influence the value and application of this factor. Thus, AF_{ED}_{ᵤ} may or may not be a function of ED_{T}_{ᵤ} and several additional factors.

AFR_{ED}_{ᵤ}—Adjustment factor used to adjust electricity delivery data to reflect the amount of renewable electricity delivered. This factor may vary greatly based on the specifics of the electricity delivery process. The availability, point and method of electricity delivery metering may also greatly influence the value and application of this factor. Thus, AFR_{ED}_{ᵤ} may or may not be a function of ED_{T}_{ᵤ} and several additional factors and data inputs.

AED_{T}_{ᵤ}—Variable representing assignment of the ED_{T}_{ᵤ} record to a record of renewable fuel credit generation. By default, the value of this variable is 0, until it is assigned to a renewable fuel credit generation record.

Block 802 is followed by block 804, in which one or more records can be established for the amount of electricity used by the EV station, which may include, but are not limited to:

t_{EU}_{ᵥ}⁻—Starting date (and time) of electricity usage in that record.

t_{EU}_{ᵥ}⁺—End date (and time) of electricity usage in that record.

EU_{T}_{ᵥ}—The amount of electricity (e.g. in kWh) that was used by the EV station in the period between t_{EU}_{ᵥ}⁻ and t_{EU}_{ᵥ}⁺.

AF_{EU}_{ᵥ}—Adjustment factor used to adjust electricity usage data (e.g. for parasitic, conversion, transportation and delivery losses). This factor may vary greatly based on the specifics of the electricity delivery process and the characteristics of the EV station. The availability, point and method of electricity usage metering may also greatly influence the value and application of this factor. Thus, AF_{EU}_{ᵥ} may or may not be a function of EU_{T}_{ᵥ} and several additional factors.

AFR_{EU}_{ᵥ}—Adjustment factor used to adjust electricity usage data to reflect the amount of renewable electricity used. This factor may vary greatly based on the specifics of the electricity usage process. The availability, point and method of electricity usage metering may also greatly influence the value and application of this factor. Thus, AFR_{ED}_{ᵤ} may or may not be a function of EU_{T}_{ᵥ} and several additional factors and data inputs.

EVU—Metering data of electricity used directly for charging of electric vehicles may or may not be available for each Tᵥ period. Thus, EVU may be used to implement estimates or approximations of electricity used as transportation fuel. This may be done, for example through establishing average usage of electricity as transportation fuel by one or more EV stations by taking into account the number, average fuel consumption and mileage of electric vehicles fueled by the EV stations. EVU may be a function of several other factors.

AEU_{T}_{ᵥ}—Variable representing assignment of the EU_{T}_{ᵥ} record to a record of renewable fuel credit generation. By default, the value of this variable is 0, until it is assigned to a renewable fuel credit generation record.

Block 804 is followed by block 806, in which evaluation and calculation of renewable fuel credit generation can be performed for different periods of renewable electricity generation and usage as transportation fuel as follows:

t_{RFC}_{_{w}}⁻—Starting date (and time) of period in which generation of renewable fuel credits is established.

t_{RFC}_{_{w}}⁺—End date (and time) of period in which generation of renewable fuel credits is established.

Values of t_{RFC}_{_{w}}⁻ and t_{RFC}_{_{w}}⁺ are largely dependent on the regulations that the generation of renewable fuel credits is based on and thus may be different for each type of renewable fuel credit that is tracked using embodiments of the disclosure.

RFC_{T}_{_{w}}—the amount of renewable fuel credits that are generated for the period between t_{RFC}_{_{w}}⁻ and t_{RFC}_{_{w}}⁺. The exact method of quantifying renewable fuel credits is regulated by the appropriate agencies and is influenced by several factors that may be established in or outside of the tracking system, but is always applied to the T_{w} period and the RED_{T}_{_{w}} amount of renewable electricity that is delivered to one or more EV stations and used as transportation fuel.

Accordingly, in the description of algorithms provided below, calculation of renewable fuel credits is indicated as follows:

RFC_{T}_{_{w}}→RFC_{T}_{_{w}}(T_{w},RED_{T}_{_{w}})

Block 806 is followed by block 808, in which the initial amount of renewable electricity that was delivered to the EV stations in each T period can be established as follows:

for each u=1 to (c−1)

RED_{T}_{ᵤ}→ED_{T}_{ᵤ}+AF_{ED}_{ᵤ}+AFR_{ED}_{ᵤ}

u→u+1

In the above equation:

c—Total number of electricity delivery records in the system.

Block 808 is followed by block 810, in which using RED_{T}_{ᵤ} values for which AED_{T}_{ᵤ}=0, the total amount renewable electricity delivered in each T_{w} period can be established. Renewable electricity delivered in T_{w} can be referred to as RED_{T}_{_{w}}.

Values of t_{RFC}_{_{w}}⁻ and t_{RFC}_{_{w}}⁺ may be established in accordance with following criteria:

t_{RFC}_{_{w}}⁻−t_{ED}_{ᵥ}⁻≦τ_{ED}⁻ and t_{RFC}_{_{w}}⁺−t_{ED}_{ᵥ}⁺≦τ_{ED}⁺

Note that the above criteria may not apply to each t_{ED}_{ᵥ}⁻ and t_{ED}_{ᵥ}⁺, but instead can be applied for the start and end time of each renewable fuel credit generation period to ensure that electricity delivery may be summarized without the need of prorating RED_{T}_{ᵤ} quantities.

In the above equation:

τ_{ED}⁻—maximum time difference allowed between the start of the electricity delivery record and the beginning of the interval for which renewable fuel credits are established.

τ_{ED}⁺—maximum time difference allowed between the end of the interval for which renewable fuel credits are established and the start of electricity delivery record.

If the above criteria cannot be satisfied, RED_{T}_{ᵤ} values may be prorated based on t_{ED}_{ᵤ}⁻, t_{ED}_{ᵤ}⁺, t_{RFC}_{_{w}}⁻ and t_{RFC}_{_{w}}⁺.

Block 810 is followed by block 812, in which if meter data for electricity usage by the EV stations is available, a determination to establish the initial amount of renewable electricity that was used by the EV stations in each Tᵥ period can be performed as follows:

for each v=1 to (d−1)

REU_{T}_{ᵥ}→EU_{T}_{ᵥ}+AF_{EU}_{ᵥ}+AFR_{EU}_{ᵥ},

v→v+1

In the above equation:

d—Total number of electricity usage records in the system.

Block 812 is followed by block 814, in which for each T_{w} period, the amount of renewable electricity that renewable fuel may be generated for is limited by the amount of electricity that is used by one or more EV stations as transportation fuel. In order to evaluate the above criteria, electricity usage by EV stations can be determined by the system for each T_{w} period—the resulting electricity values can be referred to as REU_{T}_{_{w}}.

If each REU_{T}_{ᵥ} is based on meter data recorded in the tracking system, REU_{T}_{_{w}} values can be established by summarizing all EU_{T}_{ᵥ} values for which:

AEU_{T}_{ᵥ}=0 and t_{RFC}_{_{w}}⁻−t_{EU}_{ᵥ}⁻≦τ_{EU}⁻ and t_{EU}_{ᵥ}⁺≦τ_{EU}⁺

Furthermore prorated REU_{T}_{ᵥ} values based on t_{EU}_{ᵥ}⁻, t_{EU}_{ᵥ}⁺, t_{RFC}_{_{w}}⁻ and t_{RFC}_{_{w}}⁺ can be summarized of all records for which:

AEU_{T}_{ᵥ}=0 and t_{RFC}_{_{w}}⁻−t_{EU}_{ᵥ}⁻ and t_{RFC}_{_{w}}⁺−t_{EU}_{ᵥ}⁺≦τ_{EU}⁺

or

AEU_{T}_{ᵥ}=0 and t_{RFC}_{_{w}}⁻−t_{EU}_{ᵥ}⁻≦τ_{EU}⁻ and t_{RFC}_{_{w}}⁺−t_{EU}_{ᵥ}⁺>τ_{EU}⁺

In the above equation:

τ_{EU}⁻—maximum time difference allowed between the start of the EV stations electricity usage record and the beginning of the interval for which renewable fuel credits are established.

τ_{EU}⁺—maximum time difference allowed between the end of the interval for which renewable fuel credits are established and the end of the EV stations electricity usage record.

If meter data for electricity usage by EV stations is not available, EVU can be used to establish REU_{T}_{_{w}} values. Exact usage of EVU to establish REU_{T}_{_{w}} is may vary greatly based at least in part on the specifics of the EV stations, as well as the mode of transportation and distribution of electricity. Approximation of renewable electricity usage may be executed by embodiments of the disclosure in accordance with the following, but is not limited to:

REU_{T}_{_{w}}→EVU*T_{w}

Block 814 is followed by block 816, in which one or more of the following criteria is analyzed in order to ensure that renewable fuel credits are not generated for renewable electricity that was not used as transportation fuel:

RED_{T}_{_{w}}−REU_{T}_{_{w}}≦τ_{ED}⁰

In the above equation:

T_{ED}⁰—Maximum amount by which renewable electricity delivered to one or more EV stations for the purposes of renewable fuel credit generation may exceed renewable electricity used by the EV station.

If the above criteria is not satisfied, the amount of renewable electricity delivered for which renewable fuel credits may be generated may be limited to the following:

RED_{T}_{ᵥ}→REU_{T}_{ᵥ}+τ_{ED}⁰

Block 816 is followed by block 818, in which a quantity of renewable fuel credits to be generated can be established as follows:

RFC_{T}_{_{w}}→RFC_{T}_{_{w}}(T_{w},RED_{T}_{_{w}})

Block 818 is followed by block 820, in which assignment of electricity delivery and usage records involved in current RFC_{T}_{_{w}}(T_{w},RED_{T}_{_{w}}) renewable fuel credit calculation can be assigned to the renewable fuel credit generation to assure that no double-counting of records occurs when subsequent renewable fuel credit calculations are performed as follows:

for each “u” and “v” that was involved in the calculation of RED_{T}_{_{w}} and REU_{T}_{_{w}}.

AED_{T}_{ᵤ}:ABU_{T}_{ᵥ}→w The algorithm 800 can end after block 820.

For each of algorithms 600, 700, and 800 shown in respective FIGS. 6, 7, and 8, more or less than the elements and/or operations illustrated in and/or described can exist with other embodiments of the disclosure. The process algorithms 600, 700, and 800 shown in respective FIGS. 6, 7, and 8 are provided by way of example only.

Accordingly, embodiments described herein facilitate systems and methods for tracking renewable energy credits. References are made to block diagrams of systems, methods, apparatuses, and computer program products according to example embodiments. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions, which execute on the computer or other programmable data processing apparatus, create means for implementing the functionality of at least some of the blocks of the block diagrams, or combinations of blocks in the block diagrams discussed.

The computer program instructions mentioned herein may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process, such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and so forth.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or in the alternative, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed disclosure is:

1. A system comprising:
at least one processor; and
at least one memory comprising computer-executable instructions, that when executed by the at least one processor, causes the at least one processor to:
receive data associated with renewable electricity generation by at least one power plant;
receive data associated with renewable electricity usage by at least one electric vehicle station; and
based at least in pan on the received renewable electricity generation data and renewable electricity usage data, determine one or more renewable energy credits associated with the renewable electricity generation.

2. The system of claim 1, further comprising computer-executable instructions, that when executed by the at least one processor, cause the at least one processor to:
receive feedstock procurement data from a feedstock module operable to receive the feedstock procurement data from a feedstock source, a power plant, or a third party source.

3. The system of claim 1, further comprising computer-executable instructions, that when executed by the at least one processor, cause the at least one processor to:
receive electricity generation data from a renewable electricity generation module operable to receive the electricity generation data from a power plant.

4. The system of claim 1, further comprising computer-executable instructions, that when executed by the at least one processor, cause the at least one processor to:
receive usage data for produced renewable electricity and renewable fuel credit generation data from a renewable electricity disposition module operable to receive renewable electricity generation data.

5. The system of claim 1, further comprising computer-executable instructions, that when executed by the at least one processor, cause the at least one processor to:
receive renewable fuel credit transaction data from a renewable fuel credit processing module operable to receive renewable fuel credit transaction data from one or more sources.

6. The system of claim 1, further comprising computer-executable instructions, that when executed by the at least one processor, cause the at least one processor to:
receive aggregated mass, energy, and volume flow data from a renewable fuel credit processing module operable to receive, from one or more sources, aggregated mass, energy, and volume flow data corresponding to previously generated renewable fuel credits.

7. The system of claim 1, further comprising computer-executable instructions, that when executed by the at least one processor, cause the at least one processor to:
execute one or more algorithms to match a specific mass, energy, and volume flow of a particular transaction to one or more corresponding renewable fuel credits.

8. The system of claim 7, further comprising computer-executable instructions, that when executed by the at least one processor, cause the at least one processor to:
assign one or more transactions to one or more corresponding renewable fuel credits based at least in part on a FIFO (first in, first out) approach.

9. The system of claim 7, wherein the one or more algorithms are operable to provide a genealogy of one or more renewable fuel credits.

10. A computer-implemented method comprising:
receiving data associated with renewable electricity generation by at least one power plant;
receiving data associated with renewable electricity usage by at least one electric vehicle station;
based at least in part on the received renewable electricity generation data and renewable electricity usage data, determining one or more renewable energy credits associated with the renewable electricity generation;
wherein one or more of the above operations is performed by at least one computer processor.

11. The method of claim 9, further comprising:
receiving feedstock procurement data from a feedstock source, a power plant, or a third party source.

12. The method of claim 9, further comprising:
receiving electricity generation data from a power plant.

13. The method of claim 9, further comprising:
receiving usage data for produced renewable electricity and renewable fuel credit generation data.

14. The method of claim 9, further comprising:
receiving renewable fuel credit transaction data from one or more sources.

15. The method of claim 9, further comprising:
receiving, from one or more sources, aggregated mass, energy, and volume flow data corresponding to previously generated renewable fuel credits.

16. The method of claim 9, further comprising:
executing one or more algorithms to match a specific mass, energy, and volume flow of a particular transaction to one or more corresponding renewable fuel credits.

17. The method of claim 15, further comprising:
assigning transactions to one or more corresponding renewable fuel credits based at least in part on a FIFO (first in, first out) approach.

18. The method of claim 15, wherein the one or more algorithms are operable to provide a genealogy of one or more renewable fuel credits.

19. A non-transitory computer-readable medium storing computer-executable instructions, that when executed by one or more processors, cause the one or more processors to:
receive data associated with renewable electricity generation by at least one power plant;
receive data associated with renewable electricity usage by at least one electric vehicle station; and
based at least in part on the received renewable electricity generation data and renewable electricity usage data, determine one or more renewable energy credits associated with the renewable electricity generation using one or more algorithms to match a specific mass, energy, and volume flow of a particular transaction to one or more corresponding renewable fuel credits.

20. The computer-readable medium of claim 19, wherein the one or more algorithms are operable to provide a genealogy of one or more renewable fuel credits.
